(19) United States
(12) Patent Application Publication
(10) Pub. No.: US 2025/0150142 A1
(43) Pub. Date: May 8, 2025

(54) METHOD AND APPARATUS FOR CSI REPORT FOR NETWORK ENERGY SAVING IN ADVANCED WIRELESS COMMUNICATION SYSTEMS

(71) Applicant: SAMSUNG ELECTRONICS CO., LTD., Suwon-si (KR)

(72) Inventors: Ameha Tsegaye ABEBE, Suwon-si (KR); Youngbum KIM, Suwon-si (KR); Junyung YI, Suwon-si (KR); Seongmok LIM, Suwon-si (KR); Youngrok JANG, Suwon-si (KR); Hyoungju JI, Suwon-si (KR)

(21) Appl. No.: 18/935,385

(22) Filed: Nov. 1, 2024

(30) Foreign Application Priority Data
Nov. 2, 2023 (KR) 10-2023-0150221

(51) Int. Cl. H04B 7/06; H04B 7/0456

(52) U.S. Cl. CPC H04B 7/0626; H04B 7/0456

(57) ABSTRACT

The disclosure relates to a 5G or 6G communication system for supporting a higher data transmission rate. This disclosure relates to methods and systems for the network to configure the UE with CSI report sub-configurations with the CSI reporting quantity set to “cri-RI-CQI.” The method comprises: receiving, from a base station, configuration information on a CSI reporting, wherein the configuration information includes one or more sub-configurations and a sub-configuration includes a port subset indicator; identifying one or more CSI-RS ports for the sub-configuration based on a plurality of CSI-RS ports for a channel measurement associated with the CSI reporting and the port subset indicator; obtaining CSI based on the one or more CSI-RS ports; and transmitting, to the base station, the CSI reporting including the CSI.

### CROSS-REFERENCE TO RELATED APPLICATION

This application is based on and claims priority under 35 U.S.C. § 119 to Korean Patent Application No. 10-2023-0150221 filed on Nov. 2, 2023, in the Korean Intellectual Property Office, the disclosure of which is/are incorporated by reference herein in its/their entirety.

### BACKGROUND

### 1. Field

The present disclosure relates to the field of 5^{th} generation (5G) and beyond 5G communication networks and more particularly to channel state information (CSI) report for multiple network-energy saving hypotheses (adaptation patterns).

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

The principal object of the disclosure herein is to disclose methods and apparatus for the network to configure CSI report configuration and the UE to report the CSI in accordance to the network's configurations wherein the configurations correspond to multiple network energy saving adaptation patterns.

As a yet another specific object of the disclosure herein is to disclose methods and systems for the network to configure the UE with CSI report sub-configurations corresponding to multiple network energy saving adaptation pattern. The CSI report configuration and the corresponding sub-configurations can be referred as non-PMI CSI and the configuration includes the CSI reporting quantity set to “cri-RI-CQI.”

As a yet another specific object of the disclosure herein is to disclose methods and systems for the UE to receive configuration for CSI report sub-configurations corresponding to multiple network energy saving adaptation pattern. The CSI report configuration and the corresponding sub-configurations can be referred as non-PMI CSI and the configuration includes the CSI reporting quantity set to “cri-RI-CQI,”

### SUMMARY

The present disclosure has been made to address the above-mentioned problems and disadvantages, and to provide at least the advantages described below.

In accordance with one aspect of the present disclosure, a method performed by a base station in a wireless communication system is provided, the method includes transmitting, to a terminal, configuration information about non-PMI CSI report.

In accordance with an aspect of the present disclosure, a method performed by a terminal in a communication system is provided. The method includes receiving, from a base station, configuration information on a channel state information (CSI) reporting, wherein the configuration information includes one or more sub-configurations and a sub-configuration includes a port subset indicator; identifying one or more channel state information reference signal (CSI-RS) ports for the sub-configuration based on a plurality of CSI-RS ports for a channel measurement associated with the CSI reporting and the port subset indicator; obtaining CSI based on the one or more CSI-RS ports; and transmitting, to the base station, the CSI reporting including the CSI, wherein the port subset indicator includes a plurality of bits, and each of the plurality of bits is associated with a CSI-RS port in the plurality of CSI-RS ports for the channel measurement associated with the CSI reporting, wherein indices of the one or more CSI-RS ports are indicated by one or more bits of value 1 of the port subset indicator, and wherein the indices of the one or more CSI-RS ports correspond to one or more antenna ports in an increasing order of positions of the one or more bits of value 1.

In accordance with another aspect of the disclosure, a method performed by a base station in a wireless communication system is provided. The method includes transmitting, to a terminal, configuration information on a channel state information (CSI) reporting, wherein the configuration information includes one or more sub-configurations and a sub-configuration includes a port subset indicator; and receiving, from the terminal, the CSI reporting including CSI, wherein the port subset indicator includes a plurality of bits, and each of the plurality of bits is associated with a CSI-RS port in a plurality of CSI-RS ports for a channel measurement associated with the CSI reporting, wherein indices of the one or more CSI-RS ports are indicated by one or more bits of value 1 of the port subset indicator, wherein the CSI is based on one or more CSI-RS ports, and wherein the indices of the one or more CSI-RS ports correspond to one or more antenna ports in an increasing order of positions of the one or more bits of value 1.

In accordance with another aspect of the disclosure, a user equipment (UE) in a wireless communication system is provided. The UE includes a transceiver; and a controller configured to: receive, from a base station, configuration information on a channel state information (CSI) reporting, wherein the configuration information includes one or more sub-configurations and a sub-configuration includes a port subset indicator, identify one or more channel state information reference signal (CSI-RS) ports for the sub-configuration based on a plurality of CSI-RS ports for a channel measurement associated with the CSI reporting and the port subset indicator, obtain CSI based on the one or more CSI-RS ports, and transmit, to the base station, the CSI reporting including the CSI, wherein the port subset indicator includes a plurality of bits, and each of the plurality of bits is associated with a CSI-RS port in the plurality of CSI-RS ports for the channel measurement associated with the CSI reporting, wherein indices of the one or more CSI-RS ports are indicated by one or more bits of value 1 of the port subset indicator, and wherein the indices of the one or more CSI-RS ports correspond to one or more antenna ports in an increasing order of positions of the one or more bits of value 1.

In accordance with another aspect of the disclosure, a base station in a wireless communication system is provided. The base station includes a transceiver; and a controller configured to: transmit, to a terminal, configuration information on a channel state information (CSI) reporting, wherein the configuration information includes one or more sub-configurations and a sub-configuration includes a port subset indicator, and receive, from the terminal, the CSI reporting including CSI, wherein the port subset indicator includes a plurality of bits, and each of the plurality of bits is associated with a CSI-RS port in a plurality of CSI-RS ports for a channel measurement associated with the CSI reporting, wherein indices of the one or more CSI-RS ports are indicated by one or more bits of value 1 of the port subset indicator, wherein the CSI is based on one or more CSI-RS ports, and wherein the indices of the one or more CSI-RS ports correspond to one or more antenna ports in an increasing order of positions of the one or more bits of value 1.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates an example wireless network according to various embodiments of the present disclosure;

FIG. 2A illustrates an example wireless transmit path according to various embodiments of the present disclosure;

FIG. 2B illustrates an example wireless receive path according to various embodiments of the present disclosure;

FIG. 3A illustrates an example of UE according to various embodiments of the present disclosure;

FIG. 3B illustrates an example of gNB according to various embodiments of the present disclosure;

FIG. 4 illustrates exemplary cross-polarized MIMO antenna system according to various embodiments of the present disclosure;

FIG. 5A illustrates exemplary method of aperiodic CSI reporting according to various embodiments of the present disclosure;

FIG. 5B illustrates exemplary layout for CSI-RS resource mapping in an OFDM time-frequency grid according to various embodiments of the present disclosure;

FIG. 6 illustrates an example of CSI report configuration and CSI measurement configurations that is supported in 5G NR system according to various embodiments of the present disclosure;

FIG. 7 illustrates exemplary procedure for non-PMI based CSI acquisition according to various embodiments of the present disclosure;

FIG. 8 illustrates an example of the application of the parameter non-PMI-PortIndication according to various embodiments of the present disclosure;

FIG. 9 illustrates an exemplary procedure for configuration of CSI report for multiple SD adaptation according to various embodiments of the present disclosure;

FIG. 10 illustrates exemplary embodiment of a single CSI-RS mapped to multiple SD adaptation patterns in non-PMI CSI according to various embodiments of the present disclosure;

FIG. 11 illustrates exemplary case for CSI report sub-configurations without non-PMI-PortIndication configuration and its interpretation according to various embodiments of the present disclosure;

FIG. 12 illustrates exemplary case for CSI report sub-configurations with non-PMI-PortIndication configuration configured in sub-configurations and its interpretation according to various embodiments of the present disclosure;

FIG. 13 illustrates exemplary case for CSI report sub-configurations with non-PMI-PortIndication configuration configured in sub-configurations without Non-PMI-PortIndication configuration and its interpretation according to various embodiments of the present disclosure;

FIG. 14 illustrates exemplary case for CSI report sub-configurations with a common non-PMI-PortIndication configuration configured in report configurations with Non-PMI-PortIndication configuration configured in sub-configurations and its interpretation according to various embodiments of the present disclosure; and

FIG. 15 illustrates an exemplary embodiment of sharing report configuration parameters as well as the UCI report parameters according to various embodiments of the present disclosure.

### DETAILED DESCRIPTION

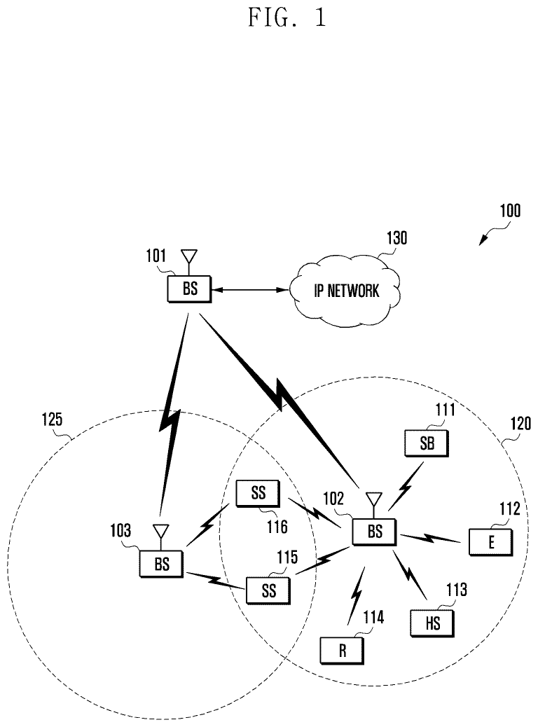

FIGS. 1 through 15 discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Furthermore, according to some embodiments, the “unit” may include one or more processors.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHZ, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like.

In the following description of the disclosure, upper layer signaling may refer to signaling corresponding to at least one signaling among the following signaling, or a combination of one or more thereof:
Master information block (MIB);
System information block (SIB) or SIB X (X=1, 2, . . . );
Radio resource control (RRC); and/or
Medium access control (MAC) control element (CE).

In addition, L1 signaling may refer to signaling corresponding to at least one signaling method among signaling methods using the following physical layer channels or signaling, or a combination of one or more thereof:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); and/or
Uplink control information (UCI).

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term “gNB” can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance etc.

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the present disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

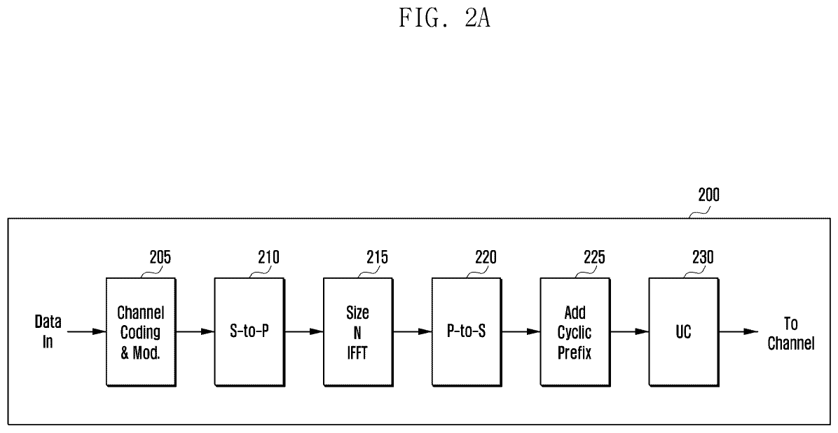

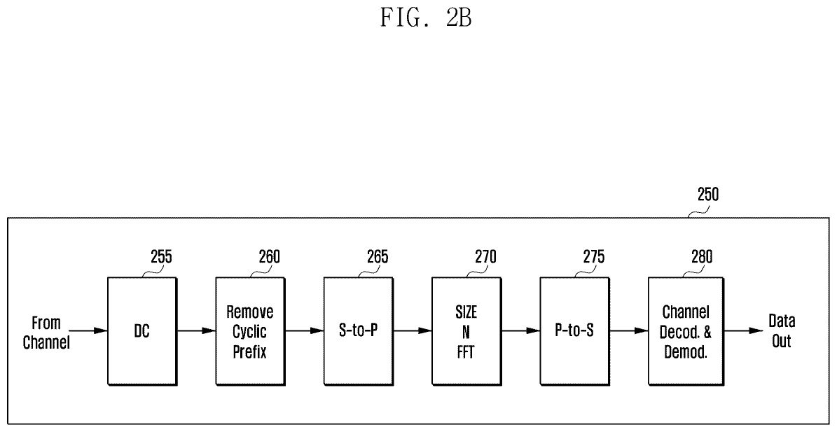

FIGS. 2A and 2B illustrate example wireless transmit and receive paths according to various embodiments of the present disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N inverse fast Fourier transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N fast Fourier transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as discrete Fourier transform (DFT) and inverse discrete Fourier transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths according to various embodiments of the present disclosure, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

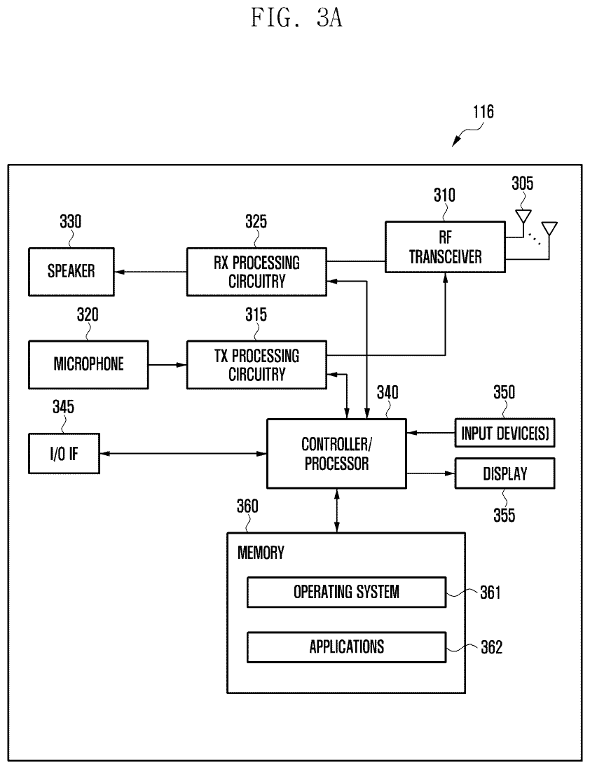

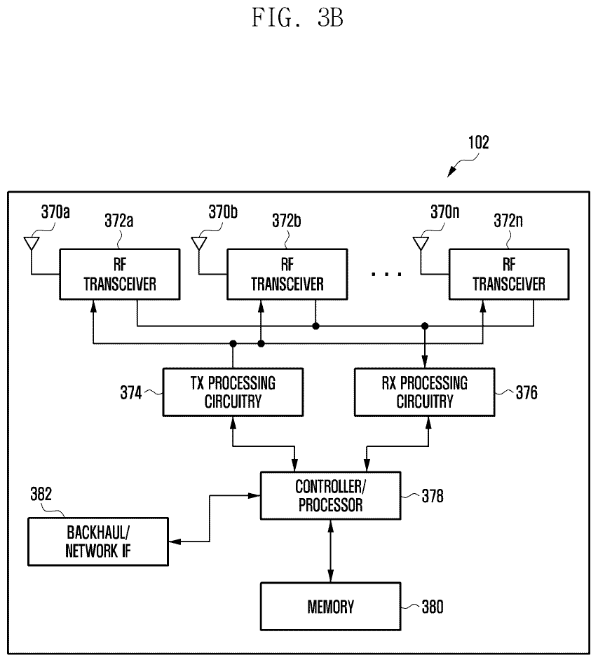

FIG. 3A illustrates an example UE 116 according to various embodiments of the present disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the present disclosure as described in embodiments of the present disclosure. The main processor 340 can move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116 according to various embodiments of the present disclosure, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to various embodiments of the present disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions is configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of a gNB 102 according to various embodiments of the present disclosure, various changes may be made to FIG. 3B. For example, the gNB 102 can include any number of each component shown in FIG. 3. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Multiple input multiple output (MIMO) system wherein a BS and/or a UE is equipped with multiple antennas has been widely employed in wireless systems for its advantages in terms of spatial multiplexing, diversity gain and array gain.

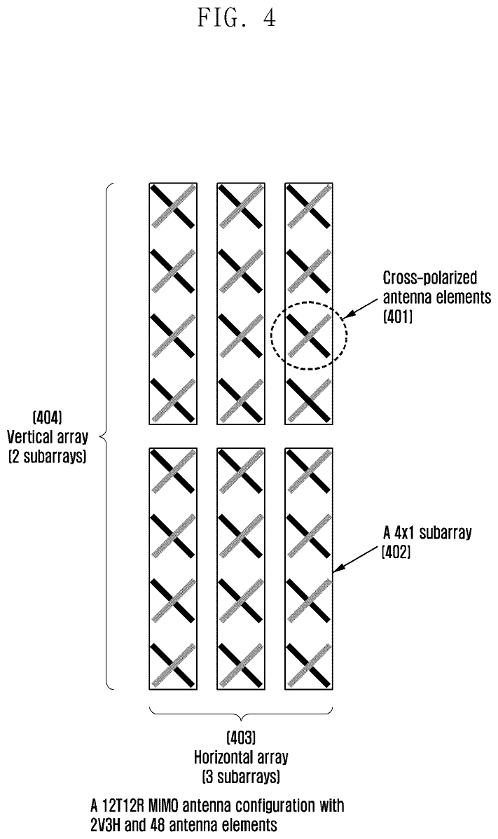

FIG. 4 illustrates an example of MIMO antenna configuration with 24 antenna elements according to various embodiments of the present disclosure. In the figure, 4 cross-polarized 401 antenna elements form a 4×1 subarray 402. 12 subarrays form a 2V3H MIMO antennas configuration including 2 and 3 subarrays in vertical and horizontal dimensions (404, 403), respectively. Although FIG. 4 illustrates one example of MIMO antenna configuration, the present disclosure can be applied to various such configurations.

In NR, a base station has a CSI framework for indicating CSI measurement and report of a UE. A CSI framework of the NR may be configured by at least two elements including resource setting and report setting, wherein the report setting refers to at least one ID of the resource setting and thus they have correlation.

According to an embodiment of the disclosure, the resource setting may include information related to a reference signal (RS) for measuring channel state information by the UE. The base station may configure at least one resource setting for the UE. For example, the base station and the UE may exchange signaling information as shown in Table 1 in order to transmit information on the resource setting.

```
TABLE 1
-- ASN1START
-- TAG-CSI-RESOURCECONFIG-START
CSI-ResourceConfig ::= SEQUENCE {
  csi-ResourceConfigId CSI-ResourceConfigId,
  csi-RS-ResourceSetList CHOICE {
    nzp-CSI-RS-SSB SEQUENCE {
      nzp-CSI-RS-ResourceSetList SEQUENCE (SIZE (1..maxNrofNZP-CSI-RS-
ResourceSetsPerConfig)) OF NZP-CSI-RS-ResourceSetId
        OPTIONAL, -- Need R
  csi-SSB-ResourceSetList SEQUENCE (SIZE (1..maxNrofCSI-SSB-ResourceSetsPerConfig))
OF CSI-SSB-ResourceSetId
        OPTIONAL -- Need R
    },
    csi-IM-ResourceSetList SEQUENCE (SIZE (1..maxNrofCSI-IM-ResourceSetsPerConfig)) OF
CSI-IM-ResourceSetId
  },
  bwp-Id BWP-Id,
  resourceType ENUMERATED { aperiodic, semiPersistent, periodic },
  ...
}
-- TAG-CSI-RESOURCECONFIG-STOP
-- ASNISTOP
```

In Table 1, signaling information CSI-ResourceConfig includes information on each resource setting. According to the signaling information, each resource setting may include a resource setting index (csi-ResourceConfigId), a BWP index (bwp-ID), a time domain transmission configuration (resourceType) of a resource, or a resource set list (csi-RS-ResourceSetList) including at least one resource set. The time domain transmission configuration of the resource may be configured to be aperiodic transmission, semi-persistent transmission, or periodic transmission. The resource set list may be a set including resource sets for channel measurement or a set including resource sets for interference measurement. When the resource set list is a set including resource sets for channel measurement, each resource set may include at least one resource, and the at least one resource may correspond to an index of a channel state information reference signal (CSI-RS) resource or a synchronization/broadcast channel block (synchronization signal/physical broadcast channel block (SS/PBCH block) or synchronization signal block (SSB)). When the resource set list is a set including resource sets for interference measurement, each resource set may include at least one interference measurement resource (CSI interference measurement (CSI-IM)).

For example, when a resource set includes a CSI-RS, the base station and the UE may exchange signaling information as shown in Table 2 in order to transmit information on the resource set.

TABLE 2
-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS-ResourcesPerSet)) OF |

NZP-CSI-RS-ResourceId,

| | | |
|---|---|---|
| repetition | ENUMERATED { on, off } | OPTIONAL, -- Need S |
| aperiodicTriggeringOffset | INTEGER(0..6) | OPTIONAL, -- Need S |
| trs-Info | ENUMERATED {true} | OPTIONAL, -- Need R |

...
}
-- TAG-NZP-CSI-RS-RESOURCESET-STOP
-- ASN1STOP

In Table 2, signaling information NZP-CSI-RS-ResourceSet includes information on each resource set. According to the signaling information, each resource set may include at least information on a resource set index (nzp-CSI-ResourceSetId) or an index set (nzp-CSI-RS-Resources) of an included CSI-RS, and may include a part of information (repetition) on a spatial domain transmission filter of the included CSI-RS resource or information (trs-Info) on whether the included CSI-RS resource has a tracking purpose.

The CSI-RS may be the most representative reference signal included in the resource set. The base station and the UE may exchange signaling information as shown in Table 3 in order to transmit information on the CSI-RS resource.

TABLE 3
-- ASN1START
-- TAG-NZP-CSI-RS-RESOURCE-START

| NZP-CSI-RS-Resource ::= | SEQUENCE { | |
|---|---|---|
| nzp-CSI-RS-ResourceId | NZP-CSI-RS-ResourceId, | |
| resourceMapping | CSI-RS-ResourceMapping, | |
| powerControlOffset | INTEGER (−8..15), | |
| powerControlOffsetSS | ENUMERATED{db−3, db0, db3, db6} | OPTIONAL, -- Need R |
| scramblingID | ScramblingId, | |
| periodicityAndOffset | CSI-ResourcePeriodicityAndOffset | OPTIONAL, -- Cond |

PeriodicOrSemiPersistent

| | | |
|---|---|---|
| qcl-InfoPeriodicCSI-RS | TCI-StateId | OPTIONAL, -- Cond Periodic |

...
}
-- TAG-NZP-CSI-RS-RESOURCE-STOP
-- ASNISTOP

In Table 3, signaling information NZP-CSI-RS-Resource includes information on each CSI-RS. The information included in the signaling information NZP-CSI-RS-Resource may have the following meanings:
nzp-CSI-RS-ResourceId: a CSI-RS resource index;
resourceMapping: resource mapping information of a CSI-RS resource;
powerControlOffset: a ratio between PDSCH EPRE (Energy Per RE) and CSI-RS EPRE;
powerControlOffsetSS: a ratio between SS/PBCH block EPRE and CSI-RS EPRE;
scramblingID: a scrambling index of a CSI-RS sequence;
periodicity AndOffset: a transmission period and slot offset of a CSI-RS resource; and
qcl-InfoPeriodicCSI-RS: TCI-state information when a corresponding CSI-RS is a periodic CSI-RS.

The “resourceMapping” included in the signaling information NZP-CSI-RS-Resource may represent resource mapping information of the CSI-RS resource, and may include resource element (RE) mapping for a frequency resource, the number of ports, symbol mapping, CDM type, frequency resource density, and frequency band mapping information. Each of the number of ports, frequency resource density, CDM type, and time-frequency domain RE mapping, which may be configured through the resource mapping information, may have a value determined in one of the rows shown in Table 4 below.

TABLE 4

| | Ports | Density | | | CDM group | | |
|---|---|---|---|---|---|---|---|
| Row | X | ρ | cdm-Type | (k, l) | index j | k′ | l′ |
| 1 | 1 | 3 | No CDM | (k₀, l₀), (k₀ + 4, l₀), (k₀ + ₈, l₀) | 0, 0, 0 | 0 | 0 |
| 2 | 1 | 1, 0.5 | No CDM | (k₀, l₀) | 0 | 0 | 0 |
| 3 | 2 | 1, 0.5 | FD-CDM2 | (k₀, l₀) | 0 | 0, 1 | 0 |
| 4 | 4 | 1 | FD-CDM2 | (k₀, l₀), (k₀ + 2, l₀) | 0, 1 | 0, 1 | 0 |
| 5 | 4 | 1 | FD-CDM2 | (k₀, l₀), (k₀, l₀ + 1) | 0, 1 | 0, 1 | 0 |
| 6 | 8 | 1 | FD-CDM2 | (k₀, l₀), (k₁, l₀), (k₂, l₀), (k₃, l₀) | 0, 1, 2, 3 | 0, 1 | 0 |
| 7 | 8 | 1 | FD-CDM2 | (k₀, l₀), (k₁, l₀), (k₀, l₀ + 1), (k₁, l₀ + 1) | 0, 1, 2, 3 | 0, 1 | 0 |
| 8 | 8 | 1 | CDM4 | (k₀, l₀), (k₁, l₀) | 0, 1 | 0, 1 | 0, 1 |
| | | | (FD2, TD2) | | | | |
| 9 | 12 | 1 | FD-CDM2 | (k₀, l₀), (k₁, l₀)(k₂, l₀), (k₃, l₀), (k₄, l₀), (k₅, l₀) | 0, 1, 2, 3, 4, 5 | 0, 1 | 0 |
| 10 | 12 | 1 | CDM4 | (k₀, l₀) (k₁, l₀) (k₂, l₀) | 0, 1, 2 | 0, 1 | 0, 1 |
| | | | (FD2, TD2) | | | | |
| 11 | 16 | 1, 0.5 | FD-CDM2 | (k₀, l₀), (k₁, l₀), (k₂, l₀), (k₃, l₀) | 0, 1, 2, 3, | 0, 1 | 0 |
| | | | | (k₀, l₀ + 1), (k₁, l₀ + 1), (k₂, l₀ + 1), (k₃, l₀ + 1) | 4, 5, 6, 7 | | |
| 12 | 16 | 1, 0.5 | CDM4 | (k₀, l₀) (k₁, l₀) (k₂, l₀), (k₃, l₀) | 0, 1, 2, 3 | 0, 1 | 0, 1 |
| | | | (FD2, TD2) | | | | |
| 13 | 24 | 1, 0.5 | FD-CDM2 | (k₀, l₀), (k₁, l₀), (k₂, l₀), (k₀, l₀ + 1), (k₁, l₀ + 1), (k₂, l₀ + 1), | 0, 1, 2, 3, 4, 5, | 0, 1 | 0 |
| | | | | (k₀, l₁), (k₁, l₁), (k₂, l₁) (k₀, l₁ + 1), (k₁, l₁ + 1), (k₂, l₁ + 1) | 6, 7, 8, 9, 10, 11 | | |
| 14 | 24 | 1, 0.5 | CDM4 | (k₀, l₀), (k₁, l₀), (k₂, l₀), (k₀, l₁), (k₁, l₁), (k₂, l₁) | 0, 1, 2, 3, 4, 5 | 0, 1 | 0, 1 |
| | | | (FD2, TD2) | | | | |
| 15 | 24 | 1, 0.5 | CDM8 | (k₀, l₀), (k₁, l₀), (k₂, l₀) | 0, 1, 2 | 0, 1 | 0, 1, |
| | | | (FD2, TD4) | | | | 2, 3 |
| 16 | 32 | 1, 0.5 | FD-CDM2 | (k₀, l₀) (k₁, l₀), (k₂, l₀), (k₃, l₀) | 0, 1, 2, 3, | 0, 1 | 0 |
| | | | | (k₀, l₀ + 1), (k₁, l₀ + 1), (k₂, l₀ + 1), (k₃, l₀ + 1), | 4, 5, 6, 7, | | |
| | | | | (k₀, l₁), (k₁, l₁), (k₂, l₁), (k₃, l₁), | 8, 9, 10, 11, | | |
| | | | | (k₀, l₁ + 1), (k₁, l₁ + 1), (k₂, l₁ + 1), (k₃, l₁ + 1) | 12, 13, 14, 15 | | |
| 17 | 32 | 1, 0.5 | CDM4 | (k₀, l₀) (k₁, l₀), (k₂, l₀), (k₃, l₀), (k₀, l₁), (k₁, l₁), (k₂, l₁), (k₃, l₁) | 0, 1, 2, 3, 4, 5, 6, 7 | 0, 1 | 0, 1 |
| | | | (FD2, TD2) | | | | |
| 18 | 32 | 1, 0.5 | CDM8 | (k₀, l₀) (k₁, l₀), (k₂, l₀), (k₃, l₀) | 0, 1, 2, 3 | 0, 1 | 0, 1, |
| | | | (FD2, TD4) | | | | 2, 3 |

Table 4 shows a frequency resource density, a CDM type, frequency and time domain starting positions (k̅, l̅) of a CSI-RS component RE pattern, and the number (k′) of frequency domain REs and the number (l̅′) of time domain REs of a CSI-RS component RE pattern, which are configurable according to the number (X) of CSI-RS ports. The above-described CSI-RS component RE pattern may be a basic unit for configuring a CSI-RS resource. Through Y=1+max (k′) number of frequency domain REs and Z=1+max (l′) number of time domain REs, the CSI-RS component RE pattern may include YZ number of REs. When the number of CSI-RS ports is 1, the position of a CSI-RS RE may be designated in a physical resource block (PRB) without restriction on subcarriers, and may be designated by a bitmap having 12 bits. When the number of CSI-RS ports is {2, 4, 8, 12, 16, 24, 32} and Y=2, the position of a CSI-RS RE may be designated for every two subcarriers in a PRB, and may be designated by a bitmap having 6 bits. When the number of CSI-RS ports is 4 and Y=4, the position of a CSI-RS RE may be designated for every four subcarriers in a PRB, and may be designated by a bitmap having 3 bits. Similarly, the position of a time domain RE may be designated by a bitmap having a total of 14 bits.

Hereinafter, a CSI report configuration is described.

According to an embodiment of the disclosure, report setting refers to at least one ID of resource setting and thus the report setting and resource setting have correlation, and resource setting(s) having correlation with report setting provides configuration information including information on a reference signal for measuring channel information. When the resource setting(s) having correlation with the report setting is used for measuring channel information, the measured channel information may be used for reporting channel information according to a reporting method configured in the report setting having correlation.

According to an embodiment of the disclosure, the report setting may include configuration information related to a CSI reporting method. For example, the base station and the UE may exchange signaling information as shown in Table 5 in order to transmit information on the report setting.

TABLE 5
-- ASN1START
-- TAG-CSI-REPORTCONFIG-START

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {s15, s110, s120, s140, s180, sl160, s1320}, |
| reportSlotOffsetList | SEQUENCE (SIZE (1..maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
  }
  },
```

| reportQuantity | CHOICE { | |
|---|---|---|
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | ENUMERATED {n2, n4} | OPTIONAL -- Need S |

},

| | |
|---|---|
| cri-RI-CQI | NULL, |
| cri-RSRP | NULL, |
| ssb-Index-RSRP | NULL, |
| cri-RI-LI-PMI-CQI | NULL |

},

| reportFreqConfiguration | SEQUENCE { | |
|---|---|---|
| cqi-FormatIndicator | ENUMERATED { widebandCQI, | OPTIONAL, -- |
| | subbandCQI } | |

Need R

| | | |
|---|---|---|
| pmi-FormatIndicator | ENUMERATED { widebandPMI, | OPTIONAL, -- |
| | subbandPMI } | |

Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| } | OPTIONAL, -- Need R | |
|---|---|---|
| timeRestrictionForChannelMeasurements | | ENUMERATED {configured, notConfigured}, |
| timeRestrictionForInterferenceMeasurements | | ENUMERATED { configured, notConfigured}, |
| codebookConfig | CodebookConfig | OPTIONAL, -- Need R |
| dummy | ENUMERATED {n1, n2} | OPTIONAL, -- Need R |
| groupBasedBeamReporting | CHOICE { | |
| enabled | NULL, | |
| disabled | SEQUENCE { | |
| nrofReportedRS | ENUMERATED {n1, n2, n3, n4} | OPTIONAL -- Need S |

```
  }
  },
```

| | | |
|---|---|---|
| cqi-Table | ENUMERATED {table1, table2, table3, spare1} | OPTIONAL, -- Need R |

| | |
|---|---|
| subbandSize | ENUMERATED {value1, value2}, |
| non-PMI-PortIndication | SEQUENCE (SIZE (1..maxNrofNZP-CSI-RS-ResourcesPerConfig)) |

```
OF PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {s14, s18, sl16} |
| } | OPTIONAL -- Need R |

]]
}

In Table 5, signaling information CSI-ReportConfig includes information on each report setting. The information included in the signaling information CSI-ReportConfig may have the following meanings:
reportConfigId: a report setting index;
carrier: a serving cell index;
resourcesForChannelMeasurement: a resource setting index for channel measurement having correlation with report setting;
csi-IM-ResourcesForInterference: a resource setting index having a CSI-IM resource for interference measurement having correlation with report setting;
nzp-CSI-RS-ResourcesForInterference: a resource setting index having a CSI-RS resource for interference measurement having correlation with report setting;
reportConfigType: it may indicate a time domain transmission configuration and transmission channel of a channel report and may have an aperiodic transmission, semi-persistent physical uplink control channel (PUCCH) transmission, semi-periodic PUSCH transmission, or periodic transmission configuration;
reportQuantity: it may indicate the type of channel information to be reported and may have the type of channel information (“cri-RI-PMI-CQI,” “cri-RI-i1,” “cri-RI-i1-CQI,” “cri-RI-CQI,” “cri-RSRP,” “ssb-Index-RSRP,” and “cri-RI-LI-PMI-CQI”) when a channel report is not transmitted (“none”) and when a channel report is transmitted. Herein, elements included in the type of the channel information may mean a channel quality indicator (CQI), a precoding matric indicator (PMI), a CSI-RS resource indicator (CRI), an SS/PBCH block resource indicator (SSBRI), a layer indicator (LI), a rank indicator (RI), and/or L1-reference signal received power (RSRP);
reportFreqConfiguration: it may indicate whether channel information to be reported includes only information on the entire band (wideband) or includes information on each subband, and may have configuration information for a subband including the channel information when information on each subband is included;
timeRestrictionForChannelMeasurements: whether the time domain is restricted for a reference signal for channel measurement among reference signals referred to by channel information to be reported;
timeRestrictionForInterferenceMeasurements: whether the time domain is restricted for a reference signal for interference measurement among reference signals referred to by channel information to be reported;
codebookConfig: codebook information referred to by channel information to be reported;
groupBasedBeamReporting: whether to perform beam-grouping of a channel report;
cqi-Table: a CQI table index referred to by channel information to be reported;
subbandSize: an index indicating the subband size of channel information; and
non-PMI-PortIndication: port mapping information referred to when non-PMI channel information is reported.

When the base station indicates channel information reporting through higher layer signaling or L1 signaling, the UE may perform channel information reporting by referring to the above configuration information included in the indicated report setting.

The base station may indicate a channel state report to the UE through higher layer signaling including RRC signaling or medium access control (MAC) control element (CE) signaling, or L1 signaling (e.g., common DCI, group-common DCI, and UE-specific DCI).

For example, the base station may indicate an aperiodic channel information report (CSI report) to the UE through higher layer signaling or DCI using DCI format 0_1. The base station configures multiple CSI report trigger states including a parameter for a CSI report or a parameter for an aperiodic CSI report of the UE through higher layer signaling. The parameter for the CSI report or the CSI report trigger state may include a set including a slot interval or a possible slot interval between a PDCCH including DCI and a PUSCH including a CSI report, a reference signal ID for channel state measurement, the type of included channel information, and the like.

When the base station indicates some of the multiple CSI report trigger states to the UE through DCI, the UE reports channel information according to a CSI report configuration of report setting configured in the indicated CSI report trigger state. The channel information reporting may be performed through a PUSCH scheduled in DCI format 0_1. Aperiodic CSI reporting may be triggered by a “CSI request” field of DCI format 0_1 corresponding to scheduling DCI for a PUSCH. The UE may monitor a PDCCH, obtain DCI format 0_1, and obtain scheduling information for the PUSCH and a CSI request indicator. The CSI request indicator may be configured in NTS (=0, 1, 2, 3, 4, 5, or 6) bits, and may be determined by higher layer signaling (reportTriggerSize). One trigger state among one or more aperiodic CSI report trigger states which may be configured through higher layer signaling (CSI-AperiodicTriggerStateList) may be triggered by the CSI request indicator.
When all bits of the CSI request field are 0, this may mean that CSI reporting is not requested.
If the number (M) of CSI trigger states in configured CSI-AperiodicTriggerStateList is greater than 2NTs−1, M number of CSI trigger states may be mapped to 2NTs−1 according to a pre-defined mapping relationship, and one of the 2NTs−1 trigger states may be indicated by the CSI request field.
If the number (M) of CSI trigger states in configured CSI-AperiodicTriggerStateList is equal to or less than 2NTs−1, one of M number of CSI trigger states may be indicated by the CSI request field.

Table 6 shows an example of a relationship between a CSI request indicator and a CSI trigger state indicatable by the corresponding indicator.

TABLE 6

| CSI request | CSI trigger | CSI- | CSI- |
|---|---|---|---|
| field | state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The UE may transmit the obtained CSI by using a PUSCH scheduled by DCI format 0_1. When 1 bit corresponding to an uplink data indicator (UL-SCH indicator) in DCI format 0_1 indicates “1,” the UE may multiplex uplink data (UL-SCH) and the obtained CSI and transmit the same to a PUSCH resource scheduled by DCI format 0_1. When the 1 bit corresponding to the uplink data indicator (UL-SCH indicator) in DCI format 0_1 indicates “0,” the UE may map and transmit only the CSI to the PUSCH resource scheduled by DCI format 0_1, without the uplink data (UL-SCH). The time domain resource allocation of the PUSCH including the CSI report of the UE may be indicated through a slot interval with the PDCCH indicated through the DCI, a start symbol and symbol length indication within a slot for the time domain resource allocation of the PUSCH, and the like. For example, the position of the slot in which the PUSCH including the CSI report of the UE is transmitted may be indicated through the slot interval with the PDCCH indicated through the DCI, and the start symbol and the symbol length within the slot may be indicated through a time domain resource assignment field of the above-described DCI.

For example, the base station may indicate a semi-persistent CSI report transmitted on a PUSCH to the UE through DCI using DCI format 0_1. The base station may activate or deactivate the semi-persistent CSI report transmitted on the PUSCH through DCI scrambled by an SP-CSI-RNTI. When the semi-persistent CSI report is activated, the UE may periodically report channel information according to a configured slot interval. When the semi-persistent CSI report is deactivated, the UE may stop the activated periodic channel information reporting.

The base station configures a parameter for a semi-persistent CSI report of the UE or multiple CSI report trigger states including the parameter for the semi-persistent CSI report through higher layer signaling. The parameter for the CSI report or the CSI report trigger state may include a set including a slot interval or a possible slot interval between a PDCCH including DCI indicating a CSI report and a PUSCH including a CSI report, a slot interval between a slot in which higher layer signaling indicating a CSI report is activated and a PUSCH including a CSI report, a slot interval period of a CSI report, the type of included channel information, and the like.

When the base station activates some of the multiple CSI report trigger states or some of multiple report settings to the UE through higher layer signaling or DCI, the UE may report channel information according to report setting included in the indicated CSI report trigger state or a CSI report configuration configured in the activated report setting. The channel information reporting may be performed through a PUSCH semi-persistently scheduled in DCI format 0_1 scrambled by an SP-CSI-RNTI. The time domain resource allocation of the PUSCH including the CSI report of the UE may be indicated through a slot interval period of the CSI report, a slot interval with a slot in which higher layer signaling is activated or a slot interval with a PDCCH indicated through DCI, a start symbol and symbol length indication within a slot for the time domain resource allocation of the PUSCH, and the like. For example, the position of the slot in which the PUSCH including the CSI report of the UE is transmitted may be indicated through the slot interval with the PDCCH indicated through the DCI, and the start symbol and the symbol length within the slot may be indicated through a time domain resource assignment field of DCI format 0_1.

For example, the base station may indicate a semi-persistent CSI report transmitted on a PUCCH to the UE through higher layer signaling such as MAC-CE. Through the MAC-CE signaling, the base station may activate or deactivate the semi-persistent CSI report transmitted on the PUCCH. When the semi-persistent CSI report is activated, the UE may periodically report channel information according to a configured slot interval. When the semi-persistent CSI report is deactivated, the UE may stop the activated periodic channel information reporting. The base station configures a parameter for a semi-persistent CSI report of the UE through higher layer signaling. The parameter for the CSI report may include a PUCCH resource in which the CSI report is transmitted, a slot interval period of the CSI report, the type of included channel information, and the like. The UE may transmit the CSI report through the PUCCH. Alternatively, when the PUCCH for the CSI report overlaps a PUSCH, the UE may transmit the CSI report through the PUSCH. The position of the slot in which the PUCCH including the CSI report is transmitted may be indicated through a slot interval period of the CSI report configured through higher layer signaling and a slot interval between a slot in which higher layer signaling is activated and the PUCCH including the CSI report, and a start symbol and a symbol length within the slot may be indicated through a start symbol and a symbol length for allocation of a PUCCH resource configured through higher layer signaling.

For example, the base station may indicate a periodic CSI report to the UE through higher layer signaling. The base station may activate or deactivate the periodic CSI report through higher layer signaling including RRC signaling. When the periodic CSI report is activated, the UE may periodically report channel information according to a configured slot interval. When the periodic CSI report is deactivated, the UE may stop the activated periodic channel information reporting.

The base station configures report setting including a parameter for a periodic CSI report of the UE through higher layer signaling. The parameter for the CSI report may include a PUCCH resource configuration for a CSI report, a slot interval between a slot in which higher layer signaling indicating a CSI report is activated and a PUCCH including a CSI report, a slot interval period of the CSI report, a reference signal ID for channel state measurement, the type of included channel information, and the like. The UE may transmit the CSI report through the PUCCH. Alternatively, when the PUCCH for the CSI report overlaps a PUSCH, the UE may transmit the CSI report through the PUSCH. The position of the slot in which the PUCCH including the CSI report is transmitted may be indicated through a slot interval period of the CSI report configured through higher layer signaling and a slot interval between a slot in which higher layer signaling is activated and the PUCCH including the CSI report, and a start symbol and a symbol length within the slot may be indicated through a start symbol and a symbol length for allocation of a PUCCH resource configured through higher layer signaling.

When the base station indicates an aperiodic CSI report or a semi-persistent CSI report to the UE through DCI, the UE may determine whether valid channel reporting may be performed through the indicated CSI report, by considering a channel computation time (CSI computation time) required for the CSI report. For the aperiodic CSI report or the semi-persistent CSI report indicated through the DCI, the UE may perform valid CSI reporting from an uplink symbol after a Z symbol following the end of the last symbol included in a PDCCH including the DCI indicating the CSI report. The Z symbol may vary according to a numerology of a downlink bandwidth part corresponding to the PDCCH including the DCI indicating the CSI report, a numerology of an uplink bandwidth part corresponding to a PUSCH in which the CSI report is transmitted, or the type or characteristics (report quantity, frequency band granularity, the number of ports of reference signals, a codebook type, and the like) of channel information reported in the CSI report. In other words, in order to determine a certain CSI report as a valid CSI report (to determine a corresponding CSI report as a valid CSI report), uplink transmission of the corresponding CSI report may not be performed prior to a Z_{ref} symbol including a timing advance.

In this case, the Z_{ref} symbol is an uplink symbol in which a cyclic prefix (CP) starts after a time T_{proc,CSI}=(Z)(2048+144)·κ2^{-μ}·T_{C} from the end of the last symbol of a triggering PDCCH. A detailed value of Z may follow the description below, and T_{c}=1/(Δfₘₐₓ·N_{f}), Δfₘₐₓ=480·10³ Hz, N_{f}=4096, κ=64, and μ are numerologies. In this case, μ may be agreed to use one of (μ_{PDCCH}, μ_{CSI-RS}, μ_{UL}), which causes the greatest T_{proc,CSI} value, and μ_{PDCCH} may refer to a subcarrier spacing used for PDCCH transmission, μ_{CSI-RS} may refer to a subcarrier spacing used for CSI-RS transmission, and μ_{UL} may refer to a subcarrier spacing of an uplink channel used for uplink control information (UCI) transmission for CSI reporting. In another example, μ may be agreed to use one of (μ_{PDCCH}, μ_{UL}), which causes the greatest T_{proc,CSI} value. The definitions of μ_{PDCCH} and μ_{UL} refer to the above description. For convenience of the following description, satisfying the above condition may be referred to as satisfying CSI reporting validity condition 1.

In addition, when a reference signal for channel measurement for an aperiodic CSI report indicated to the UE through DCI is an aperiodic RS, the UE may perform valid CSI reporting from an uplink symbol after a Z′ symbol following the end of the last symbol including the reference signal, and the Z′ symbol may vary according to a numerology of a downlink bandwidth part corresponding to a PDCCH including the DCI indicating the CSI report, a numerology of a bandwidth corresponding to the reference signal for channel measurement for the CSI report, a numerology of an uplink bandwidth part corresponding to a PUSCH in which the CSI report is transmitted, or the type or characteristics (report quantity, frequency band granularity, the number of ports of reference signals, a codebook type, and the like) of channel information reported in the CSI report. In other words, in order to determine a certain CSI report as a valid CSI report (to determine a corresponding CSI report as a valid CSI report), uplink transmission of the corresponding CSI report may not be performed prior to a Z_{ref}′ symbol including a timing advance.

In this case, the Z_{ref}′ symbol is an uplink symbol in which a cyclic prefix (CP) starts after a time T_{proc,CSI}′=(Z′) (2048+144)·κ2^{-μ}·T_{C} from the end of the last symbol of an aperiodic CSI-RS or an aperiodic CSI-IM triggered by a triggering PDCCH. A detailed value of Z′ may follow the description below, and T_{c}=1/(Δfₘₐₓ·N_{f}), Δfₘₐₓ=480·10³ Hz, N_{f}=4096, κ=64, and μ are numerologies. In this case, μ may be agreed to use one of (μ_{PDCCH}, μ_{CSI-RS}, μ_{UL}), which causes the greatest T_{proc,CSI} value, and μ_{PDCCH} may refer to a subcarrier spacing used for triggering PDCCH transmission, μ_{CSI-RS} may refer to a subcarrier spacing used for CSI-RS transmission, and μ_{UL} may refer to a subcarrier spacing of an uplink channel used for uplink control information (UCI) transmission for CSI reporting. In another example, u may be agreed to use one of (μ_{PDCCH}, μ_{UL}), which causes the greatest T_{proc,CSI} value. In this case, the definitions of μ_{PDCCH} and μ_{UL} refer to the above description. For convenience of the following description, satisfying the above condition may be referred to as satisfying CSI reporting validity condition 2.

When the base station indicates an aperiodic CSI report for an aperiodic reference signal to the UE through DCI, the UE may perform valid CSI reporting from a first uplink symbol which satisfies both a time point after a Z symbol following the end of the last symbol included in a PDCCH including the DCI indicating the CSI report and a time point after a Z′ symbol following the end of the last symbol including the reference signal. That is, in the case of aperiodic CSI reporting based on the aperiodic reference signal, the CSI report is determined as a valid CSI report when both CSI reporting validity conditions 1 and 2 are satisfied.

When a CSI reporting time point indicated by the base station does not satisfy a CSI computation time requirement, the UE may determine that the corresponding CSI report is not valid and may not consider updating of a channel information state for the CSI report.

The above-described Z and Z′ symbols for calculation of the CSI computation time follow Table 7 and Table 8. For example, when channel information reported in the CSI report includes only wideband information, the number of ports of the reference signal is 4 or less, the number of RS resources is 1, and a codebook type is “typeI-SinglePanel” or the type (report quantity) of channel information to be reported is “cri-RI-CQI,” the Z and Z′ symbols follow value Z₁, Z₁′ of Table 8. This will be referred to as delay requirement 2. In addition, when a PUSCH including the CSI report does not include a TB or a HACK-ACK and a CPU occupation of the UE is 0, the Z and Z′ symbols follow value Z₁, Z₁′ of Table 7, which is referred to as delay requirement 1. The CPU occupation is described below in detail. In addition, when the report quantity is “cri-RSRP” or “ssb-Index-RSRP,” the Z and Z′ symbols follow value Z₃, Z₃′ of Table 8. X₁, X₂, X₃, and X₄ of Table 8 denote UE capability for a beam reporting time, and KB₁ and KB₂ of Table 8 denote UE capability for a beam changing time. In a case which does not correspond to the type or characteristics of the channel information reported in the CSI report, the Z and Z′ symbols follow value Z₂, Z₂′ in Table 8.

TABLE 7

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

TABLE 8

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₁ |
| 1 | 33 | 30 | 72 | 69 | 33 | X₂ |
| 2 | 44 | 42 | 141 | 140 | min(44, X₃ + KB₁) | X₃ |
| 3 | 97 | 85 | 152 | 140 | min(97, X₄ + KB₂) | X₄ |

When the base station indicates an aperiodic/semi-persistent/periodic CSI report to the UE, the base station may configure a CSI reference resource to determine a reference time and frequency for a channel to be reported in the CSI report. A frequency of the CSI reference resource may be carrier and subband information for measuring CSI, indicated in a CSI report configuration, and the carrier and subband information may correspond to a carrier and reportFreqConfiguration in CSI-ReportConfig which is higher layer signaling, respectively. A time of the CSI reference resource may be defined based on a time at which the CSI report is transmitted. For example, when CSI report #X is indicated to be transmitted in uplink slot n′ of a BWP and a carrier for transmitting a CSI report, a time of a CSI reference resource of CSI report #X may be defined as downlink slot n-n_{CSI-ref} of a BWP and a carrier for measuring CSI. Downlink slot n is calculated as n=└n′·2^{μ}^{_{DL}}/2^{μ}^{_{UL}}┘, when a numerology of the BWP and carrier for measuring the CSI is referred to as μDL and a numerology of the BWP and carrier for transmitting CSI report #X is referred to as μUL. When CSI report #X transmitted in uplink slot n′ is a semi-persistent or periodic CSI report, nCSI-ref which is a slot interval between the downlink slot n and a CSI reference signal follows n_{CSI-ref}=4·2^{μ}^{_{DL}} when a single CSI-RS resource is connected to the corresponding CSI report and follows n_{CSI-ref}=5·2^{μ}^{_{DL}} when multiple CSI-RS resources are connected to the corresponding CSI report, according to the number of CSI-RS/SSB resources for channel measurement. When CSI report #X transmitted in uplink slot n′ is an aperiodic CSI report, n_{CSI-ref} may be calculated as n_{CSI-ref}=└Z′/N_{symb}^{slot}┘ by considering CSI computation time Z′ for channel measurement. N_{symb}^{slot} may be the number of symbols included in one slot, and N_{symb}^{slot}=14 is assumed in NR.

When the base station indicates the UE to transmit a certain CSI report in uplink slot n′ through higher layer signaling or DCI, the UE may report CSI by performing channel measurement or interference measurement with respect to a CSI-RS resource, a CSI-IM resource, and an SSB resource transmitted not later than a CSI reference resource slot of the CSI report transmitted in uplink slot n′ from among the CSI-RS resource, the CSI-IM resource, and the SSB resource associated with the corresponding CSI report. The CSI-RS resource, the CSI-IM resource, or the SSB resource associated with the corresponding CSI report may refer to a CSI-RS resource, a CSI-IM resource, or an SSB resource included in a resource set configured in resource setting referred to by report setting for the CSI report of the UE configured through higher layer signaling, a CSI-RS resource, a CSI-IM resource, or an SSB resource referred to by a CSI report trigger state including a parameter for the corresponding CSI report, or a CSI-RS resource, a CSI-IM resource, or an SSB resource indicated by an ID of a reference signal (RS) set.

In embodiments of the disclosure, CSI-RS/CSI-IM/SSB occasions may be transmission time points of CSI-RS/CSI-IM/SSB resource(s) determined by a higher layer configuration or a combination of the higher layer configuration and DCI triggering. For example, a slot in which a semi-persistent or periodic CSI-RS resource is transmitted is determined according to a slot period and a slot offset configured through higher layer signaling, and transmission symbol(s) in the slot is determined according to resource mapping information (resourceMapping). In another example, a slot in which an aperiodic CSI-RS resource is transmitted is determined according to a slot offset with a PDCCH including DCI indicating a channel report configured through higher layer signaling, and transmission symbol(s) in the slot is determined according to resource mapping information (resourceMapping).

The above-described CSI-RS occasion may be determined by independently considering a transmission time point of each CSI-RS resource or by collectively considering transmission time points of one or more CSI-RS resource(s) included in a resource set, and accordingly, the following two interpretations may be possible for a CSI-RS occasion according to each resource set configuration.
Interpretation 1-1: from a start time point of the earliest symbol to an end time point of the latest symbol in which one specific resource among one or more CSI-RS resources included in resource set(s) configured in resource setting referred to by report setting configured for a CSI report is transmitted.
Interpretation 1-2: from a start time point of the earliest symbol in which a CSI-RS resource transmitted at the earliest time point is transmitted to an end time point of the latest symbol in which a CSI-RS resource transmitted at the latest time point is transmitted among all CSI-RS resources included in resource set(s) configured in resource setting referred to by report setting configured for a CSI report.

Hereinafter, in embodiments of the disclosure, the individual application is possible in consideration of both the two interpretations for the CSI-RS occasion. Further, both the two interpretations for the CSI-IM occasion and the SSB occasion can be considered as in the CSI-RS occasion, but the principle thereof is similar to the above description, and thus an overlapping description is omitted hereinafter.

In embodiments of the disclosure, “the CSI-RS/CSI-IM/SSB occasions for CSI report #X transmitted in uplink slot n′” refer to a set of CSI-RS occasions, CSI-IM occasions, and SSB occasions which are not later than a CSI reference resource of CSI report #X transmitted in uplink slot n′ among a CSI-RS occasion, a CSI-IM occasion, and an SSB occasion of a CSI-RS resource, a CSI-IM resource, and an SSB resource included in a resource set configured in resource setting referred to by report setting configured for CSI report #X.

In embodiments of the disclosure, “the latest CSI-RS/CSI-IM/SSB occasions among the CSI-RS/CSI-IM/SSB occasions for CSI report #X transmitted in uplink slot n′” may have two interpretations below.
Interpretation 2-1: a set of occasions including the latest CSI-RS occasion among CSI-RS occasions for CSI report #X transmitted in uplink slot n′, the latest CSI-IM occasion among CSI-IM occasions for CSI report #X transmitted in uplink slot n′, and the latest SSB occasion among SSB occasions for CSI report #0 transmitted in uplink slot n′.
Interpretation 2-2: the latest occasion among all of CSI-RS occasions, CSI-IM occasions, and SSB occasions for CSI report #X transmitted in uplink slot n′.

Hereinafter, in embodiments of the disclosure, the individual application is possible in consideration of both the two interpretations for “the latest CSI-RS/CSI-IM/SSB occasions among the CSI-RS/CSI-IM/SSB occasions for CSI report #X transmitted in uplink slot n′.” When the above-described two interpretations (interpretation 1-1 and interpretation 1-2) are considered for the CSI-RS occasion, the CSI-IM occasion, and the SSB occasion, “the latest CSI-RS/CSI-IM/SSB occasions among the CSI-RS/CSI-IM/SSB occasions for CSI report #X transmitted in uplink slot n′” can be individually applied in consideration of all of four different interpretations (the application of interpretation 1-1 and interpretation 2-1, the application of interpretation 1-1 and interpretation 2-2, and the application of interpretation 1-2 and interpretation 2-1, and the application of interpretation 1-2 and interpretation 2-2) in embodiments of the disclosure.

The base station may indicate a CSI report by considering the amount of channel information that may be simultaneously computed by the UE for a CSI report, that is, the number of channel information computation units (CSI processing units, CPUs) of the UE. When the number of channel information computation units that may be simultaneously computed by the UE is N_{CPU}, the UE may not expect a CSI report indication of the base station, which requires channel information computations more than N_{CPU}, or may not consider updating of channel information which requires channel information computations more than N_{CPU}. N_{CPU} may be reported by the UE to the base station through higher layer signaling or may be configured by the base station through higher layer signaling.

It is assumed that the CSI report indicated to the UE by the base station occupies some or all of the CPUs for channel information computation among the total number N_{CPU} of pieces of channel information that may be simultaneously computed by the UE. If the number of channel information computation units required for each CSI report, for example, CSI report n (n=0, 1, . . . , N−1) is O_{CPU}⁽ⁿ⁾, the number of channel information computation units required for a total of N CSI reports may be Σₙ₌₀^{N-1}O_{CPU}⁽ⁿ⁾. The channel information computation unit required for each reportQuantity configured in the CSI report may be configured as shown in Table 9 below.

TABLE 9
- O_{CPU}⁽ⁿ⁾ = 0 : case where reportQuantity configured in CSI report is
configured as “none,” and trs-Info is configured in CSI-RS resource set
connected to CSI report
- O_{CPU}⁽ⁿ⁾ = 1 : case where reportQuantity configured in CSI report is
configured as “none,” “cri-RSRP,” or “ssb-Index-RSRP,” and trs-Info
is not configured in CSI-RS resource set connected to CSI report
- case where reportQuantity configured in CSI report is configured as
“cri-RI-PMI-CQI,” “cri-RI-i1,” “cri-RI-i1-CQI,” “cri-RI-CQI,” or
“cri-RI-LI-PMI-CQI”
>> O_{CPU}⁽ⁿ⁾ = N_{CPU} : case where aperiodic CSI report is triggered and
corresponding CSI report is not multiplexed with one or all of
TB/HARQ-ACK. Case where corresponding CSI report is wideband CSI,
corresponds to up to 4 CSI-RS ports, and corresponds to a single resource
with no CRI report, and codebookType corresponds to “typeI-SinglePanel”
or reportQuantity corresponds to “cri-RI-CQI”
(this case is a case corresponding to the above-described delay requirement
1 and may be regarded as a case where a UE rapidly computes and reports
CSI by using all available CPUs)
>> O_{CPU}⁽ⁿ⁾ = Kₛ : all cases except the above cases. Kₛ indicates the
number of CSI-RS resources in CSI-RS resource set for channel
measurement

When the number of channel information computations required by the UE for multiple CSI reports at a specific time point is greater than the number N_{CPU} of channel information computation units that may be simultaneously computed by the UE, the UE may not consider updating of channel information for some CSI reports. Among the indicated multiple CSI reports, a CSI report for which updating of channel information is not considered may be determined by at least considering a time for which channel information computation required for the CSI report occupies CPUs and a priority of channel information to be reported. For example, regarding the time for which the channel information computation required for the CSI report occupies the CPUs, updating of channel information for a CSI report starting at the latest time point may not be considered, and updating of channel information for a CSI report having a low priority of channel information may not be preferentially considered.

The priority of the channel information may be determined with reference to Table 10 below.

TABLE 10
CSI priority value Pri_{iCSI}(y, k, c, s) = 2 · N_{cells} · Mₛ · y + N_{cells} · Mₛ · k +
Mₛ · c + s,
- y = 0 case of aperiodic CSI report transmitted through PUSCH, y = 1
case of semi-persistent CSI report transmitted through PUSCH, y = 2
case of semi-persistent CSI report transmitted through PUCCH, y = 3
case of periodic CSI report transmitted through PUCCH;
- k = 0 case where CSI report includes L1-RSRP, k = 1 case where CSI
report does not include L1-RSRP;
- c : serving cell index, N_{cells}: maximum number of serving cells
configured through higher layer signaling (maxNrofServingCells);
- s : CSI report configuration index (reportConfigID), Mₛ: maximum
number of CSI report configurations configured through higher layer
signalling (maxNrofCSI-ReportConfigurations).

A CSI priority for a CSI report is determined through priority values Pri_{iCSI}(y, k, c, s) of Table 10. Referring to Table 10, a CSI priority value is determined through the type of channel information included in the CSI report, time domain report characteristics (aperiodic, semi-persistent, and periodic) of the CSI report, a channel (PUSCH or PUCCH) through which the CSI report is transmitted, a serving-cell index, and a CSI report configuration index. The CSI priority for the CSI report is determined by comparing the priority values Pri_{iCSI}(y, k, c, s) such that a CSI report having a lower priority value has a higher CSI priority.

If a time for which channel information computation required for a CSI report indicated by the base station to the UE occupies CPUs is a CPU occupation time, the CPU occupation time is determined by considering the type (report quantity) of channel information included in the CSI report, time domain characteristics (aperiodic, semi-persistent, and periodic) of the CSI report, a slot or a symbol occupied by higher layer signaling or DCI indicating the CSI report, and a part or all of a slot or a symbol occupied by a reference signal for channel state measurement.

A combination of CSI report setting and a CSI resource configuration may be supported based on Table 11 below.

TABLE 11

| CSI-RS | Periodic CSI | Semi-Persistent | Aperiodic CSI |
|---|---|---|---|
| Configuration | Reporting | CSI Reporting | Reporting |
| Periodic | No dynamic | For reporting on | Triggered by DCI; |
| CSI-RS | triggering/ | PUCCH, the UE | additionally, |
| | activation | receives an | activation command |
| | | activation command | [10, TS 38.321] |
| | | [10, TS 38.321]; | possible as defined |
| | | for reporting on | in Subclause |
| | | PUSCH, the UE | 5.2.1.5.1. |
| | | receives triggering | |
| | | on DCI | |
| Semi-Persistent | Not | For reporting on | Triggered by DCI; |
| CSI-RS | Supported | PUCCH, the UE | additionally, |
| | | receives an | activation command |
| | | activation command | [10, TS 38.321] |
| | | [10, TS 38.321]; | possible as defined |
| | | for reporting on | in Subclause |
| | | PUSCH, the UE | 5.2.1.5.1. |
| | | receives triggering | |
| | | on DCI | |
| Aperiodic | Not | Not | Triggered by DCI; |
| CSI-RS | Supported | Supported | additionally, |
| | | | activation command |
| | | | [10, TS 38.321] |
| | | | possible as defined |
| | | | in Subclause |
| | | | 5.2.1.5.1. |

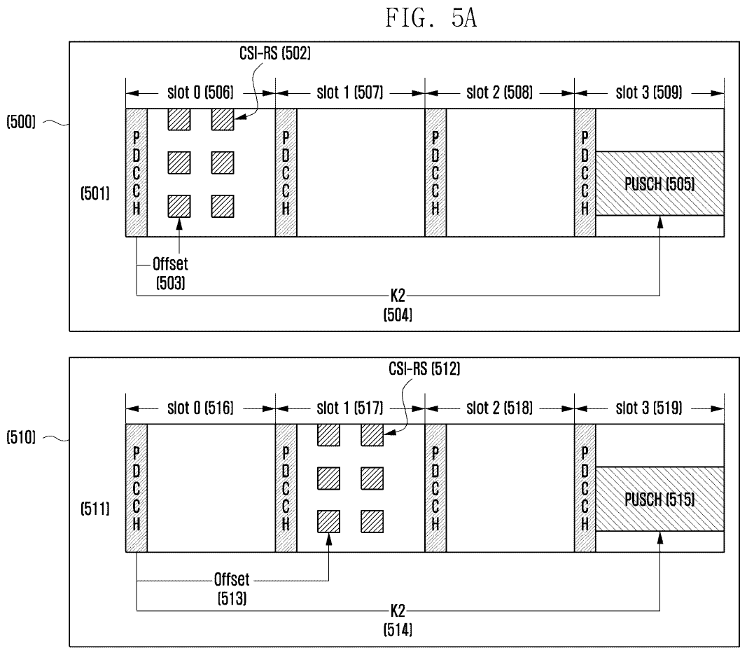

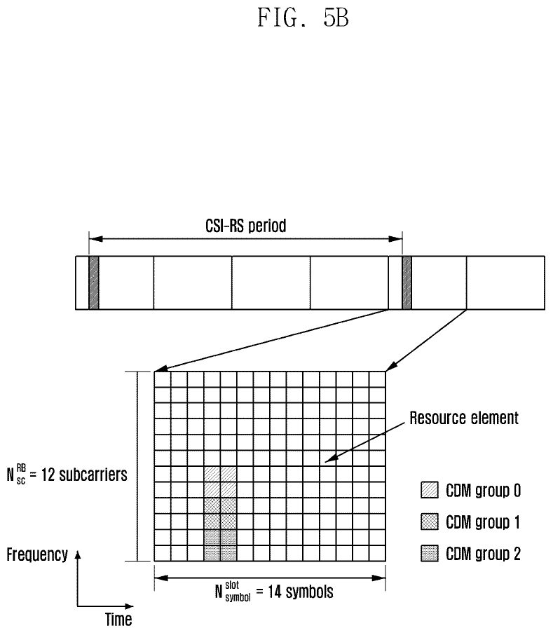

FIG. 5A illustrates an example of an aperiodic CSI reporting method according to various embodiments of the present disclosure.

In reference numeral 500 of FIG. 5A, a UE may obtain DCI format 0_1 by monitoring a PDCCH 501, and may obtain scheduling information and CSI request information for a PUSCH 505 therefrom. The UE may obtain resource information for a CSI-RS 502 to be measured from a received CSI request indicator. The UE may determine a time point at which the UE may measure the transmitted CSI-RS resource 502, based on a time point at which DCI format 0_1 is received and a parameter (aperiodicTriggeringOffset) for an offset within a CSI resource set configuration (e.g., an NZP CSI-RS resource set configuration (NZP-CSI-RS-ResourceSet)). In detail, the UE may receive, from a base station, through higher layer signaling, a configuration of an offset value X of the parameter aperiodicTriggeringOffset in the NZP-CSI-RS resource set configuration, and the configured offset value X may refer to an offset between a slot where a CSI-RS resource is transmitted and a slot where DCI triggering an aperiodic CSI report is received. For example, a value of the parameter aperiodicTriggeringOffset and the offset value X may have a mapping relationship shown in Table 12 below.

TABLE 12

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

Reference numeral 500 shows an example in which the above-described offset value is configured as X=0. In this case, the UE may receive the CSI-RS 502 in a slot (corresponding to slot 0 506 of FIG. 5A) in which DCI format 0_1 triggering an aperiodic CSI report is received, and may report, to the base station, CSI information measured by the received CSI-RS through the PUSCH 505. The UE may obtain, from DCI format 0_1, scheduling information (information corresponding to each field of DCI format 0_1) for the PUSCH 505 for the CSI report. For example, the UE may obtain information on a slot in which the PUSCH 505 is to be transmitted from the above-described time domain resource allocation information for the PUSCH 505 in DCI format 0_1. In reference numeral 500, the UE has obtained 3 as a K2 value corresponding to a slot offset value for PDCCH-to-PUSCH, and accordingly, the PUSCH 505 may be transmitted from slot 3 509 that is 3 slots away from slot 0 506, i.e., a time point when the PDCCH 501 is received.

In reference numeral 510 of FIG. 5A, the UE may obtain DCI format 0_1 by monitoring a PDCCH 511, and may obtain scheduling information and CSI request information for a PUSCH 515 therefrom. The UE may obtain resource information for a CSI-RS 512 to be measured from a received CSI request indicator. Reference numeral 510 of FIG. 5A shows an example in which the above-described offset value for the CSI-RS is configured as X=1. In this case, the UE may receive the CSI-RS 512 in a slot (corresponding to slot 0 516 of FIG. 5A) in which DCI format 0_1 triggering an aperiodic CSI report is received, and may report, to the base station, CSI information measured by the received CSI-RS through the PUSCH 515.

An aperiodic CSI report may include at least one or both of CSI part 1 and CSI part 2, and when the aperiodic CSI report is transmitted through a PUSCH, the aperiodic CSI report may be multiplexed with a transport block. For multiplexing, a CRC may be inserted into input bits of aperiodic CSI, may undergo encoding and rate matching, and then may be mapped to a resource element in the PUSCH in a specific pattern to be transmitted. The CRC insertion may be omitted according to a coding method or the length of the input bits. When CSI part 1 or CSI part 2 included in the aperiodic CSI report is multiplexed, the number of modulation symbols calculated for rate matching may be calculated as shown in below.

For CSI part 1 transmission on PUSCH not using repetition type B with UL-SCH, the number of coded modulation symbols per layer for CSI part 1 transmission, denoted as Q_{CSI-part1}′, is determined as follows:

$${Q}_{CSI - 1}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI - 1}^{′} \} .$$

For CSI part 1 transmission on an actual repetition of a PUSCH with repetition Type B with UL-SCH, the number of coded modulation symbols per layer for CSI part 1 transmission, denoted as Q_{CSI-part1}′, is determined as follows:

$${Q}_{CSI - 1}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI - 1}^{′} , {\sum }_{l = 0}^{{N}_{symb , actual}^{PUSCH} - 1} {M}_{sc , actual}^{UCI} ( l ) - {Q}_{ACK / CG - UCI - 1}^{′} \}$$

For CSI part 1 transmission on PUSCH without UL-SCH, the number of coded modulation symbols per layer for CSI part 1 transmission, denoted as Q_{CSI-part1}′, is determined as follows:
if there is CSI part 2 to be transmitted on the PUSCH,

$${Q}_{CSI - 1}^{′} = min \{ ⌈ \frac{( {O}_{CSI - 2} + {L}_{CSI - 2} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$$

$$else$$

$${Q}_{CSI - 1}^{′} = {\sum }_{l = 0}^{{N}_{symb , all}^{PUSCH} - 1} {M}_{sc}^{UCI} ( l ) - {Q}_{ACK}^{′}$$

$$end if$$

For CSI part 2 transmission on PUSCH not using repetition type B with UL-SCH, the number of coded modulation symbols per layer for CSI part 2 transmission, denoted as Q_{CSI-part2}′, is determined as follows:

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc , nominal}^{UCI} ( l ) ⌉ - {Q}_{ACK / CG - UCI - 1}^{′} - {Q}_{CSI - 1}^{′} \} .$$

For CSI part 2 transmission on an actual repetition of a PUSCH with repetition Type B with UL-SCH, the number of coded modulation symbols per layer for CSI part 2 transmission, denoted as Q_{CSI-part2}′, is determined as follows:

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI - 1}^{′} - {Q}_{CSI - 1}^{′} , {\sum }_{l = 0}^{{N}_{symb , actual}^{PUSCH} - 1} {M}_{sc , actual}^{UCI} ( l ) - {Q}_{ACK / CG - UCI - 1}^{′} - {Q}_{CSI - 1}^{′} \}$$

For CSI part 2 transmission on PUSCH without UL-SCH, the number of coded modulation symbols per layer for CSI part 2 transmission, denoted as Q_{CSI-part2}′, is determined as follows:

$${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′} .$$

In particular, in the case of PUSCH repetitive transmission types A and B, the UE may multiplex and transmit an aperiodic CSI report only on a first repetitive transmission among PUSCH repetitive transmissions. This is because aperiodic CSI report information that is multiplexed is encoded in a polar code scheme, and in this case, to perform multiplexing on several PUSCH repetitions, each PUSCH repetition is required to have the same frequency and time resource allocation. In particular, in the case of PUSCH repetition type B, since each actual repetition may have a different OFDM symbol length, the aperiodic CSI report may be multiplexed and transmitted only on a first PUSCH repetition.

In addition, in PUSCH repetitive transmission type B, when the UE receives DCI that schedules an aperiodic CSI report or activates a semi-persistent CSI report without scheduling of a transport block, even when the number of PUSCH repetitive transmissions configured through higher layer signaling is greater than 1, a value of nominal repetition may be assumed to be 1. In addition, when the UE schedules or activates an aperiodic or semi-persistent CSI report without scheduling of a transport block based on PUSCH repetitive transmission type B, the UE may expect that a first nominal repetition is the same as a first actual repetition. For a PUSCH transmitted with semi-persistent CSI based on PUSCH repetitive transmission type B without scheduling of DCI after a semi-persistent CSI report is activated by the DCI, if the first nominal repetition is different from the first actual repetition, transmission for the first nominal repetition may be ignored.

In MIMO systems, the channel state information (CSI) is required at the base station (BS) so that a signal from the BS is received at the UE with maximum possible received power and minimum possible interference. The acquisition of CSI at the BS can be via a measurement at the BS from an UL reference signal or via a measurement and feedback by the UE from a DL reference signal for time-domain duplexing (TDD) and frequency-domain duplexing (FDD) systems, respectively. In 5G FDD systems, the channel state information reference signal (CSI-RS) is the primary reference signal that is used by the UE to measure and report CSI.

In some embodiments, a UE may receive a configuration signaling from a BS for a CSI-RS that can be used for channel measurement. An example of such configuration is illustrated in FIG. 5B. Figure FIG. 5B illustrates exemplary layout for channel state information reference signal (CSI-RS) resource mapping in an orthogonal frequency division multiple access (OFDM) time-frequency grid. In the figure, 12 antenna ports (CSI-RS ports) are mapped to a CSI-RS with 3 code-domain multiplexing (CDM) groups, wherein each CDM group is mapped to 4 resource elements (REs) in OFDM time-frequency grid. The antenna ports that are mapped to the same CDM group can be orthogonalized in code-domain by employing orthogonal cover codes. The CSI-RS configuration in FIG. 5B can be related to the MIMO antenna configuration in FIG. 4, by mapping a CSI-RS port to one of the polarization of a subarray. In the 5G NR standards, three time-domain CSI-RS resources configurations, namely: periodic, semi-persistent and aperiodic are possible. In the figure, an illustrative example of periodic configuration is given with a period of 4 slots.

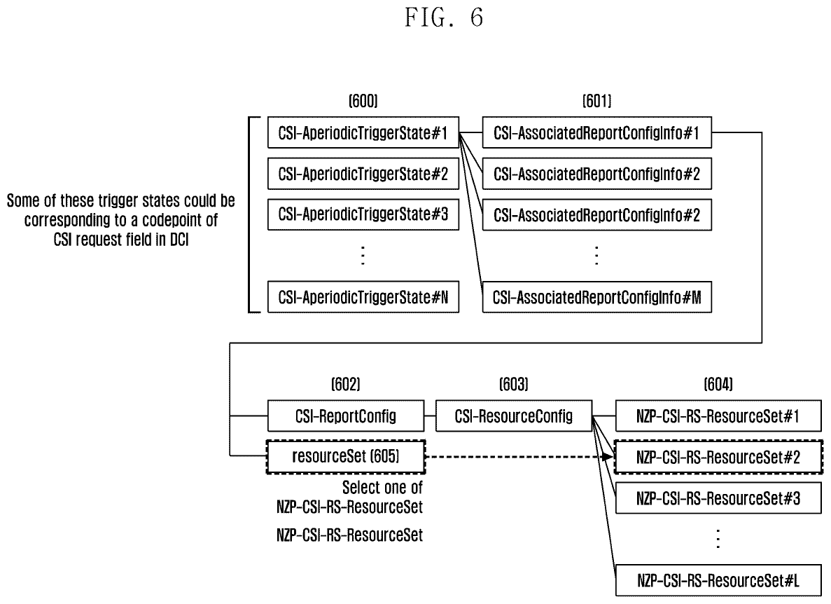

Moreover, a UE can be configured to measure a CSI feedback with a CSI report configuration. A CSI report configuration can be periodic, semi-persistent or aperiodic manner. FIG. 6 illustrates an example of CSI report configuration and CSI measurement configurations that is supported in 5G NR system. A CSI report configuration (602) can be linked to a CSI resource configuration (603). The CSI resource configuration (602) may contain one or more CSI resource sets (604) for channel measurement (CMR) or inference measurement (IMR).

In the case of periodic (P) and semi-persistent (SP) CSI report setting, the CSI resource configuration is associated with a single CSI resource set. In case of aperiodic (AP) CSI report, a UE can be configured with multiple CSI report triggering states (600). A downlink control information (DCI) may include CSI request which indicates one of the configured triggering states. Moreover, the DCI with CSI request may also contain a resource set selection field (605) to select one of the resources sets (604).

Moreover, a CSI report can be configured with one of the CSI reporting quantities. This may include CSI resource indicator (CRI), the rank indicator (RI), precoding matrix indicator (PMI), channel quality indicator (CQI), layer indicator (LI), SINR, RSRP. In 5G NR, various CSI reporting quantiles are adopted. In particular, an RRC parameter reportQuantity set to either “none,” “cri-RI-PMI-CQI,” “cri-RI-i1,” “cri-RI-i1-CQI,” “cri-RI-CQI,” “cri-RSRP,” “cri-SINR,” “ssb-Index-RSRP,” “ssb-Index-SINR,” “cri-RI-LI-PMI-CQI,” “cri-RSRP-Index,” “ssb-Index-RSRP-Index,” “cri-SINR-Index,” or “ssb-Index-SINR-Index.”

The CSI reporting can be used for transmission beam management (BM), specifically, in higher frequency bands, e.g., in frequency range 2 (FR2). In this case, the gNB may configure the UE to report one of the following quantities including, “cri-RSRP,” “cri-SINR,” “ssb-Index-RSRP,” “ssb-Index-SINR,” “cri-RSRP-Index,” “ssb-Index-RSRP-Index,” “cri-SINR-Index,” or “ssb-Index-SINR-Index.”

For a yet another purpose, the CSI report can be used for the downlink transmission CSI including “cri-RI-PMI-CQI,” “cri-RI-i1,” “cri-RI-i1-CQI,” “cri-RI-CQI.”

The aforementioned CSI report may contain PMI when the configured reporting quantity is “cri-RI-PMI-CQI,” or “cri-RI-PMI-CQI-LI.” On the other hand, the CSI report may not contain PMI when the configured reporting quantity is “cri-RI-CQI” which is commonly referred to as non-PMI-based CSI report.

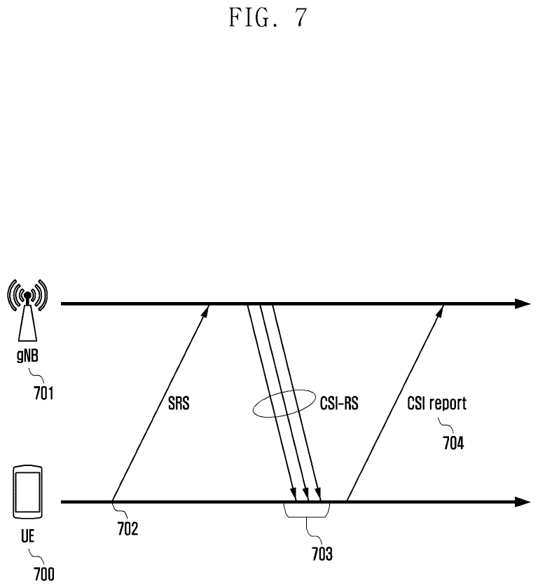

FIG. 7 illustrates exemplary procedure for non-PMI based CSI acquisition according to various embodiments of the present disclosure. Therein, the gNB (701) estimates the channel through uplink measurement, e.g., via SRS measurement (702). The gNB may then calculate precoder for one or more precoding hypothesis, wherein the precoding hypotheses may associates with different rank, different TRP, different analogue beam, etc. Then, the gNB precodes the CSI-RS resources with one or more precoders derived. The individual CSI-RS resources may correspond to transmissions by individual analogue beam or from individual TRP. Moreover, the CSI-RS ports in nonPMI-based CSI correspond to MIMO transmission layers. The gNB may precode the CSI-RS resources with different rank and precoding assumptions. For example, the gNB may precode an 8 ports CSI RS resources with multiple rank assumptions, e.g., for ank∈{1, 2, . . . , 8}. The port to MIMO layer mapping can be predefined or provided to the UE via higher layer parameter. After receiving the CSI-RS resources, a UE may report CSI (704) with CSI reporting quantity cri-RI-CQI where the cri indicates the CSI-RS resource, RI indicates the UE's preferred rank and CQI indicates the corresponding channel quality information.

In 5G NR, the precoded CSI-RS ports to layer mapping can be configured explicitly via higher layer parameter non-PMI-PortIndication or derived a predefined mapping if this parameter is not configured.

In the legacy 5G NR, if the UE is configured with a CSI-ReportConfig with the higher layer parameter reportQuantity set to “cri-RI-CQI,” and if the UE is configured with higher layer parameter non-PMI-PortIndication contained in a CSI-ReportConfig, r ports are indicated in the order of layer ordering for rank r and each CSI-RS resource in the CSI resource setting is linked to the CSI-ReportConfig based on the order of the associated NZP-CSI-RS-ResourceId in the linked CSI resource setting for channel measurement given by higher layer parameter resourcesForChannelMeasurement. The configured higher layer parameter non-PMI-PortIndication contains a sequence p₀⁽¹⁾, p₀⁽²⁾, p₁⁽²⁾, p₀⁽³⁾, p₁⁽³⁾, p₂⁽³⁾, . . . p₀^{(R)}, p₁^{(R)}, . . . p_{R-1}^{(R)} of port indices, where p₀^{(v)}, . . . , pᵥ₋₁^{(v)} are the CSI-RS port indices associated with rank v and R∈{1, 2, . . . , P} where P∈{1,2,4,8} is the number of ports in the CSI-RS resource. The UE may only report RI corresponding to the configured fields of PortIndexFor8Ranks.

If the UE is configured with a CSI-ReportConfig with the higher layer parameter reportQuantity set to “cri-RI-CQI,” and if the UE is not configured with higher layer parameter non-PMI-PortIndication, the UE assumes, for each CSI-RS resource in the CSI resource setting linked to the CSI-ReportConfig, that the CSI-RS port indices p₀^{(v)}, . . . , pᵥ₋₁^{(v)}={0, . . . , v−1} are associated with ranks v=1, 2, . . . , P where P∈{1,2,4,8} is the number of ports in the CSI-RS resource.

If the UE is configured with a CSI-ReportConfig with the higher layer parameter reportQuantity set to “cri-RI-CQI,” then when calculating the CQI for a rank, the UE may use the ports indicated for that rank for the selected CSI-RS resource. The precoder for the indicated ports may be assumed to be the identity matrix scaled by

$$\frac{1}{\sqrt{v}} .$$

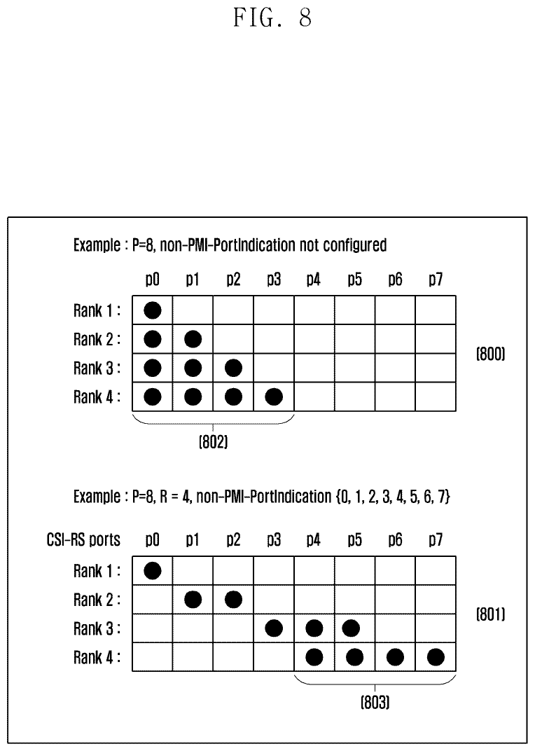

FIG. 8 illustrates exemplary cases for CSI ports to MIMO layers mapping when the higher layer parameter non-PMI-PortIndication is not configured (800) and is configured (801). CSI-RS with 8 ports is considered and layers mapping up to rank=4 is depicted. When the higher layer parameter non-PMI-PortIndication is not configured, the MIMO layers for each rank is mapped in ascending order from the first port. Thus, as illustrated in (800), the four layers for rank=4 hypothesis are mapped from the first to the fourth port. Whereas, when the higher layer parameter non-PMI-PortIndication is configured, e.g., non-PMI-PortIndication={0,1,2,3,4,5,4,5,67}, the ports to layer mapping is depicted in (801). Thus, the four MIMO layers for rank=4 are mapped to the ports from 4 through 7 (803).

Network energy saving (NES) is one of the important aspects considered for future wireless communication networks. Several methods to adjust the network's transmission power can be considered in order to save network's energy. One solution is to adjust the network's transmit power depending on the traffic condition and users' channel conditions. This can be referred power-domain (PD) NES adaptation.

In a yet another domain, i.e., the spatial domain, the number of antenna elements, TXRUs or antenna ports can be fully or partially deactivated to reduce the transmit power. This is referred to as spatial-domain (SD) NES adaptation.

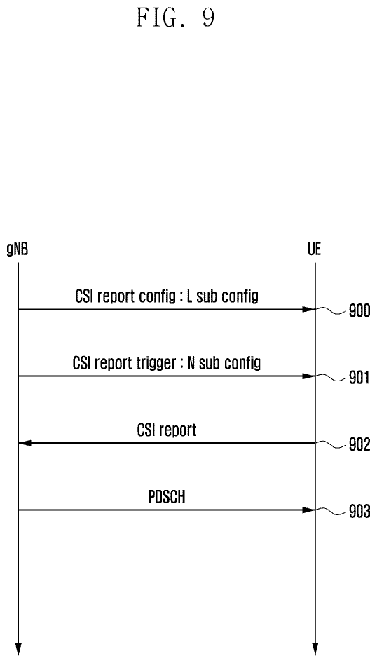

In both PD and SD adaptation, the UE may be configured to report CSI corresponding to more than one adaptation patterns. The procedure for such configuration is illustrated in FIG. 9. FIG. 9 illustrates an exemplary procedure for configuration of CSI report for multiple SD adaptation. In particular, the CSI report configuration may include L CSI (900) report sub-configuration, wherein, each sub-configuration is associated with an NES adaptation pattern. Among these L sub-configuration N≤L sub-configurations, can be triggered (901) for reporting. When a CSI report configuration is triggered with N sub-configuration, the UE reports N CSI reports (sub-reports) (902) associated to the triggered CSI report sub-configurations. In case of periodic CSI reporting, in the absence of a triggering or activation message from the gNB, L CSI reports corresponding to all configured the L sub-configurations are reported. Based on the CSI report, the gNB may transmit downlink data on a PDSCH (903).

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In the following, multitude of embodiments of the present disclosure are listed wherein the multiple CSI reports associated with reporting sub-configurations with reportingQuantity set to “cri-CQI-RI” wherein each of the sub-configurations are supported per CSI-RS resources. Moreover, a sub-configuration in the multiple sub-configurations may be associated with an individual NES adaptation pattern.

In one embodiment of the present disclosure, the CSI report configuration with CSI reportQuantity set to “cri-RI-CQI” includes multiple sub-configurations. Each sub-configuration may be associated with an individual spatial domain adaptation pattern.

In one embodiment of this disclosure, when the UE is configured with CSI report configuration with reporting quantity set to “cri-RI-CQI” and if the CSI report configuration includes L CSI report sub-configurations
In the case of periodic CSI report, the UE reports L CRIs, L RIs and L CQIs.
In the case of semi-persistent CSI report and if the UE receives CSI report activation message which activates N CSI sub-configurations, the UE reports, N CRIs, N RIs and N CQIs.

In the case of aperiodic CSI report and if the UE receives CSI report triggering message which triggers N CSI sub-configurations, the UE reports, N CRIs, N RIs and N CQIs.

In some cases, the network may restrict the UE to report the same CRI and RI across the multiple sub-configurations. This may help the network to make accurate decisions on the NES strategy as it may provide fair comparison between the multiple CSI measurement reporting (NES) hypotheses. Such restriction may also help the UE to reduce the CSI reporting complexity, as the same CRI and RI is assumed among the reported sub-configurations. Additionally, it saves some uplink CSI report overhead which would have been consumed by reporting multiple CRIs and RIs. In this case, a reported CRI and RI are shared among the reports corresponding to multiple sub-configurations.

In one embodiment of this disclosure, when the UE is configured with CSI report configuration with reporting quantity set to “cri-RI-CQI” and if the CSI report configuration includes the L CSI report sub-configurations.
In the case of periodic CSI report, the UE reports a CRI, an RI and L CQIs.
In the case of semi-persistent CSI report and if the UE receives CSI report activation message which activates N CSI sub-configurations, the UE reports, a CRI, an RI and N CQIs.
In the case of aperiodic CSI report and if the UE receives CSI report triggering message which triggers N CSI sub-configurations, the UE reports, a CRI, an RI and N CQIs.

In some cases, the restriction may apply to only to CRI only and may not apply to the RI. This may be applicable in some cases as deriving the same RI for sub-configuration may result in sub-optimal reporting, e.g., when the rank indicated by RI is not the best (applicable) to some sub-configurations.

In one embodiment of the present disclosure, when the UE is configured with CSI report configuration with reporting quantity set to “cri-RI-CQI” and if the CSI report configuration includes the L CSI report sub-configurations.
In the case of periodic CSI report, the UE reports a CRI, L RIs and L CQIs.
In the case of semi-persistent CSI report and if the UE receives CSI report activation message which activates N CSI sub-configurations, the UE reports, a CRI, N RIs and N CQIs.
In the case of aperiodic CSI report and if the UE receives CSI report triggering message which triggers N CSI sub-configurations, the UE reports, a CRI, N RIs and N CQIs.

In some case, it is beneficial if the above restriction or CSI reporting component sharing is indicated by higher layer parameter or along activation/triggering messages.

In one embodiment of the present disclosure, the CSI report configuration may include parameters for CSI component restriction/sharing, e.g., higher layer parameter CRI-RI-sharing. As an example, according to the present disclosure, if the CSI report configuration indicates CRI-RI-sharing and the UE reports N CSI reports corresponding to the same CSI report configuration, the UE reports one CRI, one RI and N CQIs.

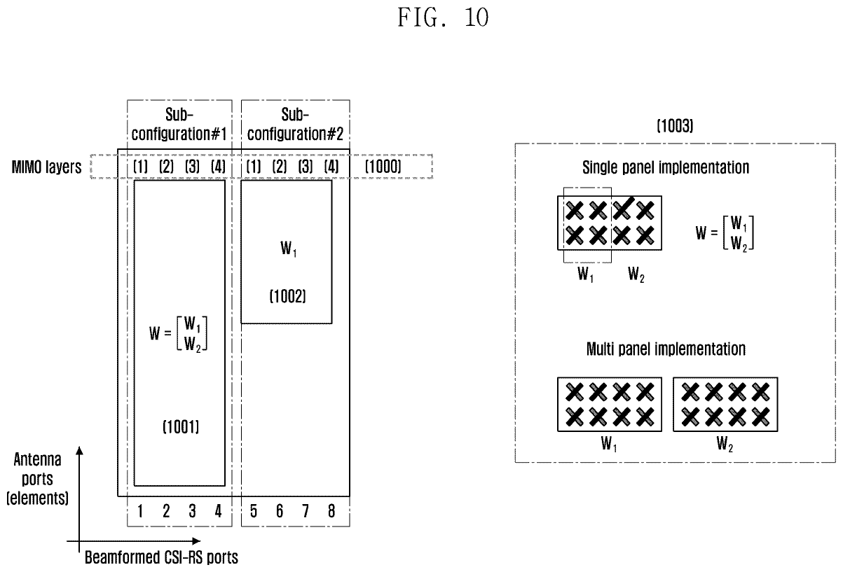

One exemplary case for multiple spatial-domain adaptation is illustrated in FIG. 10. FIG. 10 illustrates exemplary embodiment of a single CSI-RS mapped to multiple SD adaptation patterns in non-PMI CSI. In the figure, two SD adaptations are illustrated wherein one (1001) involves all the antenna elements/ports while the other involves half of the antenna ports/elements (1002). The transmission corresponding to (1001) requires higher transmit power as compared to (1002). In the figure, the CSI-RS resource includes 8 CSI-RS ports, wherein the first four ports are associated with the first sub-configuration and the second four ports correspond to the second sub-configuration. In both sub configurations up to rank 4 can be supported. Such adaptation can be achieved using single panels or multi-panels (1003). In the following, the present disclosure provides several solutions as part of this disclosure in regard to cases wherein the parameter non-PMI-PortIndication is configured or not configured.

When a CSI report configuration is configured with reportQuantity set to “cri-RI-CQI” and the configuration includes multiple sub-configurations wherein a sub-configuration correspond to an SD adaptation pattern, and when the higher layer parameter non-PMI-PortIndication is not configured, the present disclosure provides the following solutions.

If the UE is configured with a CSI-ReportConfig that contains a list of sub-configurations, provided by the higher layer parameter CSI-ReportSubConfigList:
The UE expects to be configured with the higher layer parameter codebookType set to “typeI-SinglePanel” or “typeI-MultiPanel.” If the UE indicates a capability for supporting mixed codebook combination in a slot, each sub-configuration can be configured with the higher layer parameter codebookType set to “typeI-SinglePanel” or “typeI-MultiPanel.”
Each sub-configuration can be configured with an antenna port subset using the higher layer bitmap parameter port-subsetIndicator which contains the bit sequence p₀, p₁, . . . , p_{Pm-1}, where p₀ is the MSB and p_{Pm-1} is the LSB, bit pᵢ corresponds to antenna port 3000+i, and Pm is the number of ports nrofPorts configured for the CSI-RS resources(s) within the NZP-CSI-RS-ResourceSet contained in the CSI-ResourceConfig for channel measurement that corresponds to the CSI-ReportConfig. A bit value 0 in port-subsetIndicator indicates that the corresponding antenna port is disabled for the sub-configuration, whereas bit value 1 indicates that the antenna port is enabled and belongs to the antenna port subset for the sub-configuration. For the derivation of PMI, antenna ports corresponding to all bits with value of 1 in port-subsetIndicator are mapped to consecutive antenna ports starting at CSI-RS antenna port 3000 in increasing order of the bit position in port-subsetIndicator.
A sub-configuration can be configured with a list of NZP CSI-RS resources, provided by [nzp-CSI-RS-resourceList], which indicates one or more NZP CSI-RS resources, within the NZP-CSI-RS-ResourceSet contained in the CSI-ResourceConfig for channel measurement which corresponds to the CSI-ReportConfig.
A sub-configuration can be configured with a power offset provided by [powerOffset].
If a sub-configurations is not configured with [nzp-CSI-RS-resourceList] then the sub-configuration may be associated with all the NZP CSI-RS resources within the NZP-CSI-RS-ResourceSet contained in the CSI-ResourceConfig for channel measurement which corresponds to the CSI-ReportConfig.
the UE reports CSI(s) for one or more sub-configurations according to 3GPP standard specification TS 38.214 and according to the higher layer parameter reportQuantity configured for that CSI-ReportConfig.
The UE does not expect the higher layer parameter reportQuantity to be set to “cri-RSRP,” “cri-SINR,” or “cri-SINR-Index.”

In one aspect of the present disclosure, a mapping mechanism for port index to MIMO layers corresponding to rank v, is provided when the higher layer parameter reportQuantity set to “cri-RI-CQI” and the parameter non-PMI-PortIndication is not configured.

If the UE is configured with a CSI-ReportConfig with the higher layer parameter reportQuantity set to “cri-RI-CQI,”
if the UE is not configured with higher layer parameter non-PMI-PortIndication and if the CSI-ReportConfig contains a list of sub-configurations, provided by the higher layer parameter csi-ReportSubConfigList, and if the sub-configuration is configured with an antenna port subset using the higher layer bitmap parameter port-subsetIndicator which contains the bit sequence p₀, p₁, . . . , p_{Pm-1}, where p₀ is the MSB and p_{Pm-1} is the LSB, bit pᵢ corresponds to antenna port 3000+i, and Pm is the number of ports nrofPorts configured for the CSI-RS resources(s) within the NZP-CSI-RS-ResourceSet contained in the CSI-ResourceConfig for channel measurement that corresponds to the CSI-ReportConfig. Then, the UE assumes, for each CSI-RS resource in the CSI resource setting linked to the CSI-ReportSubConfig, that the CSI-RS port indices p₀^{(v)}, . . . , pᵥ₋₁^{(v)} are associated with ranks v=1, 2, . . . , P where P∈{1,2,4,8} is the number bits with value of 1 in port-subsetIndicator. The CSI-RS port indices p₀^{(v)}, . . . , pᵥ₋₁^{(v)} correspond to antenna ports corresponding to all bits with value of 1 in port-subsetIndicator in the consecutive order where p₀^{(v)} and pᵥ₋₁^{(v)} correspond to the MSB and LSB with value of 1, respectively.
When calculating the CQI for a rank, the UE may use the ports indicated for that rank for the selected CSI-RS resource. The precoder for the indicated ports may be assumed to be the identity matrix scaled by

$$\frac{1}{\sqrt{v}} .$$

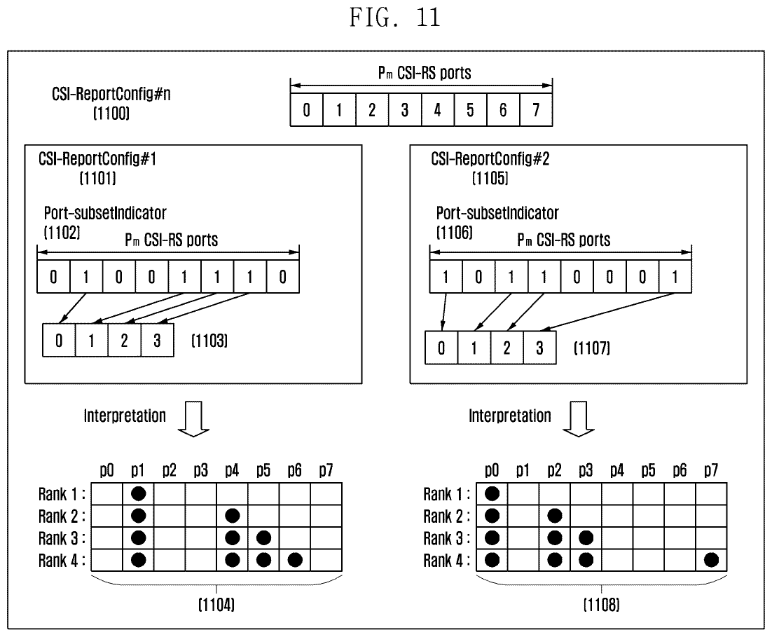

FIG. 11 illustrates exemplary case for CSI report sub-configurations without non-PMI-PortIndication configuration and its interpretation according to various embodiments of the present disclosure. In the figure, the number of CSI-RS ports corresponding to CSI-ReportConfig #n (1100) is Pₘ. For example, Pₘ can be 8. The CSI-ReportConfig #n (1100) includes two sub-configuration and each of the two sub-configurations (1101) and (1105) contain port-subsetIndicator, i.e., (1102) and (1106). According to the example, the CSI-RS ports range from 0 to P−1 instead of 0 to Pₘ−1 where P is the number bits with value of 1 in port-subsetIndicator (P=4 in the example) after the indices are remapped based on the indicated Port-subsetIndicator. For example, for CSI-ReporSubConfig #1 (1101), CSI-RS ports p1, p4, p5, and p6 (1103) are indicated by Port-subsetIndication (1102) and for CSI-ReporSubConfig #2 (1105), CSI-RS ports p0, p2, p3, and p5 (1107) are indicated by Port-subsetIndication (1106). Thus, the CSI-RS ports for each rank of each sub-configuration are interpreted as shown in (1104) and (1108), respectively.

In one aspect of the present disclosure, a mapping mechanism to map port indices to MIMO layers corresponding to rank v, is provided for the case in which the higher layer parameter reportQuantity is set to “cri-RI-CQI” and the parameter non-PMI-PortIndication is configured in the subconfiguration.

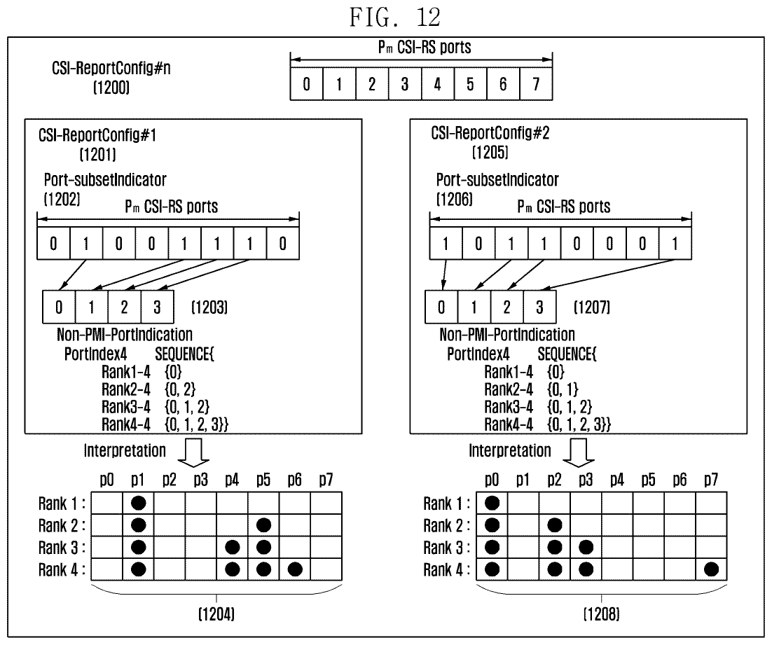

If the parameter port-subsetIndicator is configured in CSI-ReportSubConfig, then the ports indicated in the non-PMI-PortIndication can be mapped to indices after port index remapping. FIG. 12 illustrates one example of such case.

FIG. 12 illustrates exemplary case for CSI report sub-configurations with non-PMI-PortIndication configuration configured in sub-configurations and its interpretation according to various embodiments of the present disclosure. In the figure, each of the two sub-configurations (1201) and (1205) contain port-subsetIndicator, i.e., (1202) and (1206). According to the example, the CSI-RS ports range from 0 to P−1 instead of 0 to Pₘ−1 where P is the number bits with value of 1 in port-subsetIndicator (P=4 in the example) after the indices are remapped based on the indicated Port-subsetIndicator. For example, for CSI-ReporSubConfig #1 (1201), CSI-RS ports p1, p4, p5, and p6 (1203) are indicated by Port-subsetIndication (1202) and for CSI-ReporSubConfig #2 (1205), CSI-RS ports p0, p2, p3, and p7 (1207) are indicated by Port-subsetIndication (1206). Thus, the Non-PMI-PortIndication in the two configurations along with the Port-subsetIndication parameters are interpreted as shown in (1204) and (1208), respectively.

If the UE is configured with a CSI-ReportConfig with the higher layer parameter reportQuantity set to “cri-RI-CQI,”
if the CSI-ReportConfig contains a list of sub-configurations provided by the higher layer parameter csi-ReportSubConfigList and if the UE is configured with higher layer parameter non-PMI-PortIndication contained in a CSI-ReportSubConfig, and if the sub-configuration is configured with an antenna port subset using the higher layer bitmap parameter port-subsetIndicator which contains the bit sequence p₀, p₁, . . . , p_{Pm-1}, where p₀ is the MSB and p_{Pm-1} is the LSB, bit pᵢ corresponds to antenna port 3000+i, and Pm is the number of ports nrofPorts configured for the CSI-RS resources(s) within the NZP-CSI-RS-ResourceSet contained in the CSI-ResourceConfig for channel measurement that corresponds to the CSI-ReportConfig, r ports are indicated in the order of layer ordering for rank r and each CSI-RS resource in the CSI resource setting is linked to the CSI-ReportConfig based on the order of the associated NZP-CSI-RS-ResourceId in the linked CSI resource setting for channel measurement given by higher layer parameter resourcesForChannelMeasurement. The configured higher layer parameter non-PMI-PortIndication contains a sequence p₀⁽¹⁾, p₀⁽²⁾, p₁⁽²⁾, p₀⁽³⁾, p₁⁽³⁾, p₂⁽³⁾, . . . , p₀^{(R)}, p₁^{(R)}, . . . , p_{R-1}^{(R)} of port indices, where p₀^{(v)}, . . . , pᵥ₋₁^{(v)} are the CSI-RS port indices associated with rank v and R∈{1, 2, . . . , P} where P∈{1,2,4,8} is the number bits with value of 1 in port-subsetIndicator. The UE may only report RI corresponding to the configured fields of PortIndexFor8Ranks. The port indices indicated in the higher layer parameter non-PMI-PortIndication correspond to the bits in bitmap port-subsetIndicator configured in the same CSI-ReportSubConfig with the value 1.

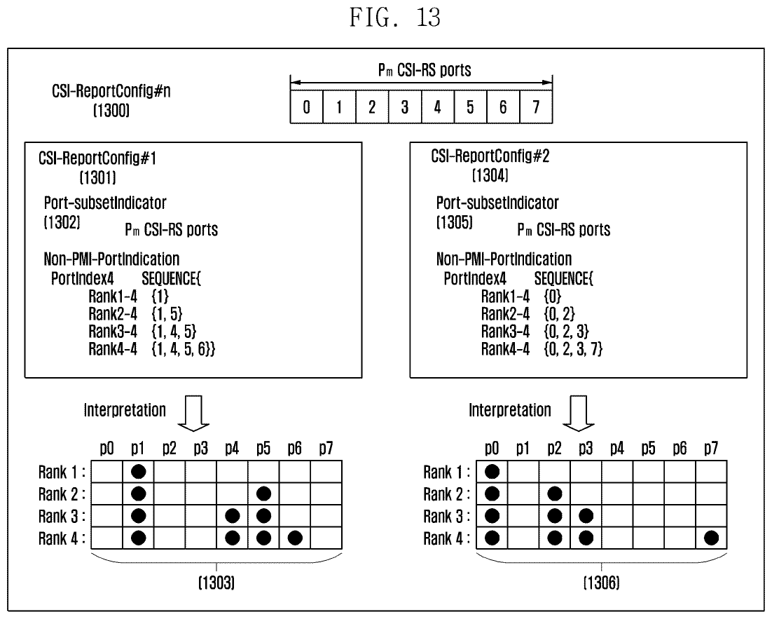

If the parameter port-subsetIndicator is not configured in CSI-ReportSubConfig, then the ports indicated in the non-PMI-PortIndication may be mapped to the original indices without remapping. FIG. 13 illustrates one example of such case.

FIG. 13 illustrates exemplary case for CSI report sub-configurations with non-PMI-PortIndication configuration configured in sub-configurations without Non-PMI-PortIndication configuration and its interpretation according to various embodiments of the present disclosure. In the figure, each of the two sub-configurations (1301) and (1304) do not contain port-subsetIndicator. According to the example, the CSI-RS ports range in non-PMI-PortIndication range from 0 to Pₘ−1. Thus, the Non-PMI-PortIndication in the two configurations are interpreted as shown in (1304) and (1308), respectively.

If the UE is configured with a CSI-ReportConfig with the higher layer parameter reportQuantity set to “cri-RI-CQI”:

if the CSI-ReportConfig contains a list of sub-configurations provided by the higher layer parameter csi-ReportSubConfigList and if the UE is configured with higher layer parameter non-PMI-PortIndication in a CSI-ReportSubConfig, and if the sub-configuration is not configured with an antenna port subset using the higher layer bitmap parameter port-subsetIndicator, r ports are indicated in the order of layer ordering for rank r and each CSI-RS resource in the CSI resource setting is linked to the CSI-ReportConfig based on the order of the associated NZP-CSI-RS-ResourceId in the linked CSI resource setting for channel measurement given by higher layer parameter resourcesForChannelMeasurement. The configured higher layer parameter non-PMI-PortIndication contains a sequence p₀⁽¹⁾, p₀⁽²⁾, p₁⁽²⁾, p₀⁽³⁾, p₁⁽³⁾, p₂⁽³⁾, . . . , p₀^{(R)}, p₁^{(R)}, . . . , p_{R-1}^{(R)} of port indices, where p₀^{(v)}, . . . , pᵥ₋₁^{(v)} are the CSI-RS port indices associated with rank v and R∈{1, 2, . . . , P} where P∈{1,2,4,8} is the number of CSI-RS ports indicated by higher layer parameter nrofPorts. The UE may only report RI corresponding to the configured fields of PortIndexFor8Ranks.

In one aspect of the present disclosure, a mapping mechanism to map port indices to MIMO layers corresponding to rank v, is provided for the case in which the higher layer parameter reportQuantity is set to “cri-RI-CQI” and the parameter non-PMI-PortIndication is configured in the CSI-ReportConfig.

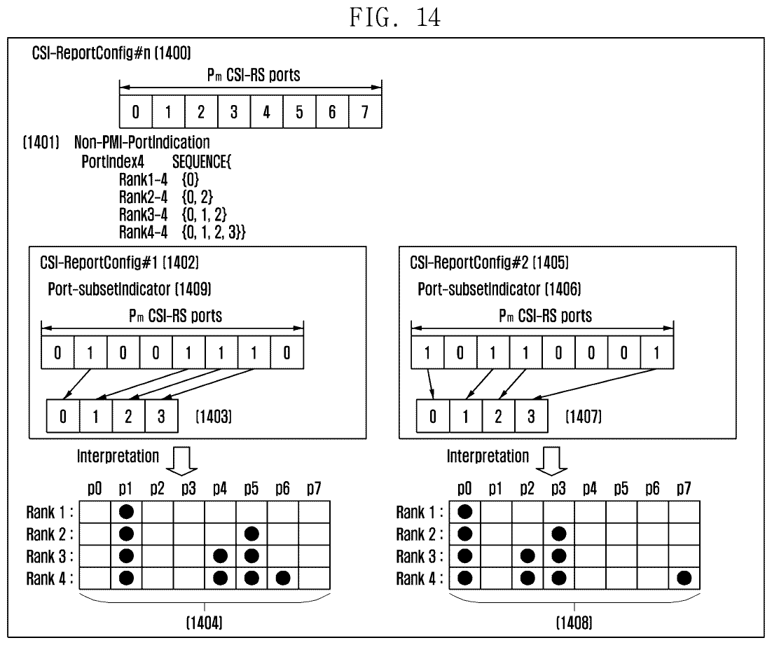

If the parameter non-PMI-PortInidcation is configured in CSI-ReportConfig, then the ports indicated in the non-PMI-PortIndication may be shared by the multiple sub-configurations. FIG. 14 illustrates one example of such case. FIG. 14 illustrates exemplary case for CSI report sub-configurations with a common non-PMI-PortIndication configuration configured in report configurations with Non-PMI-PortIndication configuration configured in sub-configurations and its interpretation. In the figure, the parameter non-PMI-PortIndication (1401) is configured in csi-ReportConfig and each of the two sub-configurations (1402) and (1405) contains port-subsetIndicator 1409 and 1406, respectively. According to the example, the CSI-RS ports range in non-PMI-PortIndication range from 0 to P−1 instead of 0 to Pₘ−1 where P is the number bits with value of 1 in port-subsetIndicator (P=4 in the example) after the indices are remapped based on the indicated Port-subsetIndicator. For the first sub-configuration (1402), CSI-RS ports p1, p4, p5, and p6 (1403) are indicated by Port-subsetIndicator (1409), and for the second sub-configuration (1405), CSI-RS ports p0, p2, p3, and p7 (1407) are indicated by Port-subsetIndicator (1406) Thus, the Non-PMI-PortIndication in the two configurations are interpreted as shown in (1404) and (1408), respectively. If the UE is configured with a CSI-ReportConfig with the higher layer parameter reportQuantity set to “cri-RI-CQI,” if the CSI-ReportConfig contains a list of sub-configurations provided by the higher layer parameter csi-ReportSubConfigList and if the UE is configured with higher layer parameter non-PMI-PortIndication contained in a CSI-ReportSubConfig, and if the sub-configuration is configured with an antenna port subset using the higher layer bitmap parameter port-subsetIndicator which contains the bit sequence p₀, p₁, . . . , p_{Pm-1}, where p₀ is the MSB and p_{Pm-1} is the LSB, bit pᵢ corresponds to antenna port 3000+i, and Pm is the number of ports nrofPorts configured for the CSI-RS resources(s) within the NZP-CSI-RS-ResourceSet contained in the CSI-ResourceConfig for channel measurement that corresponds to the CSI-ReportConfig, r ports are indicated in the order of layer ordering for rank r and each CSI-RS resource in the CSI resource setting is linked to the CSI-ReportConfig based on the order of the associated NZP-CSI-RS-ResourceId in the linked CSI resource setting for channel measurement given by higher layer parameter resourcesForChannelMeasurement. The configured higher layer parameter non-PMI-PortIndication contains a sequence p₀⁽¹⁾, p₀⁽²⁾, p₁⁽²⁾, p₀⁽³⁾, p₁⁽³⁾, p₂⁽³⁾, . . . , p₀^{(R)}, p₁^{(R)}, . . . , p_{R-1}^{(R)} of port indices, where p₀^{(v)}, . . . , pᵥ₋₁^{(v)} are the CSI-RS port indices associated with rank v and R∈{1, 2, . . . , P} where P∈{1,2,4,8} is the number bits with value of 1 in port-subsetIndicator. The UE may only report RI corresponding to the configured fields of PortIndexFor8Ranks. The port indices indicated in the higher layer parameter non-PMI-PortIndication correspond to the indices after port indices remapping. The port indices are remapped in increasing order of the bit positions where the ports corresponding to the MSB and LSB bits with value 1 are mapped to port 0 and port P−1, respectively.

In the above, if the UE is configured with multiple sub configurations and the number of bits with value of 1 in the higher layer parameter port-subsetIndicator of the multiple sub configurations are different, the UE may not be able to interpret the common non-PMI-PortIndication configuration in CSI-ReportConfig. Thus, as one aspect of the current disclosure, the following restriction is introduced to avoid such ambiguity in UE's interpretations.

If the UE is configured with a CSI-ReportConfig with the higher layer parameter reportQuantity set to “cri-RI-CQI”:

if the CSI-ReportConfig contains a list of sub-configurations provided by the higher layer parameter csi-ReportSubConfigList and if the UE is configured with higher layer parameter non-PMI-PortIndication contained in a CSI-ReportSubConfig, and if the sub-configuration is configured with an antenna port subset using the higher layer bitmap parameter port-subsetIndicator, the UE does not expect to be configured with different number of bits with value of 1 in the higher layer parameters port-subsetIndicator configured in the sub configurations. If the port Index indicated in the configured non-PMI-PortIndication for a given rank r is not in the range of port indices indicated by the Port-subsetIndicator, the UE is not expected to report CSI for the given rank corresponding to the sub configuration.

In the following, several solutions are disclosed for the case wherein a CSI-RS resource is associated to a single sub-configuration (SD adaptation). This simplifies the CSI-RS transmission as all CSI-RS ports of a CSI-RS resource are transmitted with the same transmission power. In this case, a resource group indicator is required to be indicated in the CSI-ReportSubConfiguration. This indicator indicates the applicable CSI-RS resources for a particular sub-configuration.

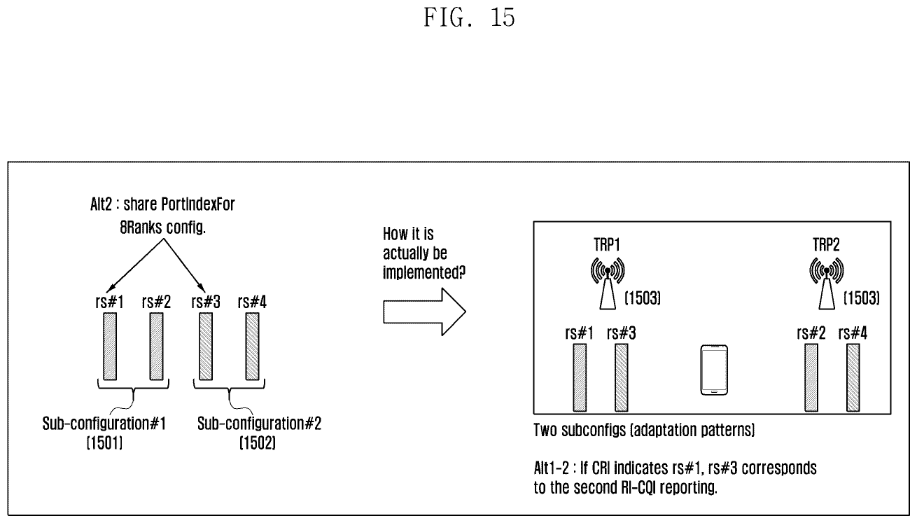

As one aspect of the present disclosure, an interpretation for the reported CRI corresponding to the sub-configuration is provided. FIG. 15 illustrates exemplary embodiment of a single CSI-RS mapped to a single SD adaptation patterns in non-PMI CSI. In FIG. 15, two sub-configurations (1501) and (1502) are configured with two CSI-RS resources each. The two CSI-RS resources correspond two transmit analogue beams or TRPs (1503, 1504), thus the reported CRI per sub configurations may select one of the two sub-configurations. Conversely, the two CSI-RS resource belonging to a single TRP can be used to measure CSI for two SD power adaptations (sub-configurations).

Moreover, as another aspect of this disclosure, if the gNB configures the UE with parameter CRI-Sharing in CSI report config, the UE reports a single CRI for the CSI reports corresponding to the sub-configurations of a CSI-ReportConfig.

If the UE is configured with a CSI-ReportConfig with the higher layer parameter reportQuantity set to “cri-RI-CQI.”
A sub-configuration can be configured with a list of NZP CSI-RS resources, provided by nzp-CSI-RS-resourceList, which indicates one or more NZP CSI-RS resources, within the NZP-CSI-RS-ResourceSet contained in the CSI-ResourceConfig for channel measurement which corresponds to the CSI-ReportConfig.
A UE reports CRI for a sub-configuration wherein the CRI corresponds to the list of CSI-RS resources in nzp-CSI-RS-resourceList configured in the sub configuration.
If a UE is configured with CRI-Sharing the UE reports a CRI for the sub-configurations wherein the CRI corresponds to the list of CSI-RS resources in nzp-CSI-RS-resourceList configured in each sub configuration. The UE does not expect to be configured with different number of CSI-RS resources in the nzp-CSI-RS-resourceList configured in sub configuration of a report configuration.

FIG. 15 illustrates an exemplary embodiment of sharing report configuration parameters according to various embodiments of the present disclosure, e.g., non-PMI-PortIndication, as well as the UCI report parameters, e.g., CRI. As illustrated, the UE may get configured with two CSI report sub-configurations, i.e., sub-configuration #1 (1501) and sub-configuration #2 (1502). Each of the two sub-configurations may correspond to two CSI-RS resources, i.e., RS #1 and RS #2 may correspond to sub-configuration #1 while RS #3 and RS #4 may correspond two sub-configuration #2. The gNB may configure two non-PMI-PortIndication configurations where the first non-PMI-PortIndication configuration corresponds to the first CSI-RS resource of each sub-configuration, i.e., RS #1 and RS #3. Conversely, the second non-PMI-PortIndication configuration corresponds to the second CSI-RS resource of each sub-configuration, i.e., RS #2 and RS #4. In practice, the CSI-RS resources sharing or corresponding to the same non-PMI-PortIndication configuration may be transmitted from the same antenna panel, analog beam, TRP, thus a single configuration suffices. This way, a smaller configuration overhead is required based on such embodiment of the disclosure.

Additionally, in Alt1-2, when the UE is configured with a CSI report configuration with L sub-configurations, wherein the report configuration contains M non-PMI-PortIndication and information that maps M CSI-RS resources to each of the sub-configurations, if the CSI reportQuantity is set to “cri-RI-CQI,” the UE may report a single CRI, M sets of RIs and CQIs. If the reported CRI indicates the value m∈{1, . . . , M}, the CRI indicates the m-th CSI-RS resource corresponding to each sub-configuration. As illustrated in FIG. 15, if CRI indicates the value “1,” it corresponds to the RS #1 and RS #3 of the sub-configuration #1 and sub-confguration #2, respectively. This way, a smaller reporting overhead is required based on such embodiment of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a communication system, the method comprising:
receiving, from a base station, configuration information on a channel state information (CSI) reporting, wherein the configuration information includes one or more sub-configurations and a sub-configuration includes a port subset indicator;
identifying one or more channel state information reference signal (CSI-RS) ports for the sub-configuration based on a plurality of CSI-RS ports for a channel measurement associated with the CSI reporting and the port subset indicator;
obtaining CSI based on the one or more CSI-RS ports; and
transmitting, to the base station, the CSI reporting including the CSI,
wherein the port subset indicator includes a plurality of bits each of which is associated with a CSI-RS port in the plurality of CSI-RS ports for the channel measurement associated with the CSI reporting,
wherein indices of the one or more CSI-RS ports are indicated by one or more bits of a value of 1 of the port subset indicator, and
wherein the indices of the one or more CSI-RS ports correspond to one or more antenna ports in an increasing order of positions of the one or more bits set to a value of 1.

2. The method of claim 1, wherein, in case that a non precoding matrix indicator (PMI) port indication is configured for the sub-configuration, the indices of the one or more CSI-RS ports correspond to one or more antenna ports based on the non PMI port indication, and
wherein the non PMI port indication indicates at least one CSI-RS port for each rank among the one or more CSI-RS ports.

3. The method of claim 1, wherein the CSI includes a channel quality indicator (CQI) based on the one or more CSI-RS ports.

4. The method of claim 1, wherein the port subset indicator includes a number of bits set to a value of 1 and the number of bits set to the value of 1 is one of 1, 2, 4, or 8.

5. The method of claim 1, wherein a report quantity of the CSI reporting is CSI-RS indicator (CRI)-rank indicator (RI)-CQI.

6. A method performed by a base station in a communication system, the method comprising:
transmitting, to a terminal, configuration information on a channel state information (CSI) reporting, wherein the configuration information includes one or more sub-configurations and a sub-configuration includes a port subset indicator; and
receiving, from the terminal, the CSI reporting including CSI,
wherein the port subset indicator includes a plurality of bits each of which is associated with a CSI-RS port in a plurality of CSI-RS ports for a channel measurement associated with the CSI reporting,
wherein indices of the one or more CSI-RS ports are indicated by one or more bits of a value of 1 of the port subset indicator,
wherein the CSI is based on one or more CSI-RS ports, and
wherein the indices of the one or more CSI-RS ports correspond to one or more antenna ports in an increasing order of positions of the one or more bits set to a value of 1.

7. The method of claim 6, wherein, in case that a non precoding matrix indicator (PMI) port indication is configured for the sub-configuration, the indices of the one or more CSI-RS ports correspond to one or more antenna ports based on the non PMI port indication, and
wherein the non PMI port indication indicates at least one CSI-RS port for each rank among the one or more CSI-RS ports.

8. The method of claim 6, wherein the CSI includes a channel quality indicator (CQI) based on the one or more CSI-RS ports.

9. The method of claim 6, wherein the port subset indicator includes a number of bits set to a value of 1 and the number of bits set to the value of 1 is one of 1, 2, 4, or 8.

10. The method of claim 6, wherein a report quantity of the CSI reporting is CSI-RS indicator (CRI)-rank indicator (RI)-CQI.

11. A terminal in a communication system, the terminal comprising:
a transceiver; and
a controller operably coupled to the transceiver, the controller configured to:
receive, from a base station, configuration information on a channel state information (CSI) reporting, wherein the configuration information includes one or more sub-configurations and a sub-configuration includes a port subset indicator,
identify one or more channel state information reference signal (CSI-RS) ports for the sub-configuration based on a plurality of CSI-RS ports for a channel measurement associated with the CSI reporting and the port subset indicator,
obtain CSI based on the one or more CSI-RS ports, and
transmit, to the base station, the CSI reporting including the CSI,
wherein the port subset indicator includes a plurality of bits each of which is associated with a CSI-RS port in the plurality of CSI-RS ports for the channel measurement associated with the CSI reporting,
wherein indices of the one or more CSI-RS ports are indicated by one or more bits of a value of 1 of the port subset indicator, and
wherein the indices of the one or more CSI-RS ports correspond to one or more antenna ports in an increasing order of positions of the one or more bits set to a value of 1.

12. The terminal of claim 11, wherein in case that a non precoding matrix indicator (PMI) port indication is configured for the sub-configuration, the indices of the one or more CSI-RS ports correspond to one or more antenna ports based on the non PMI port indication, and
wherein the non PMI port indication indicates at least one CSI-RS port for each rank among the one or more CSI-RS ports.

13. The terminal of claim 11, wherein the CSI includes a channel quality indicator (CQI) based on the one or more CSI-RS ports.

14. The terminal of claim 11, wherein the port subset indicator includes a number of bits set to a value of 1 and the number of bits set to the value of 1 is one of 1, 2, 4, or 8.

15. The terminal of claim 11, wherein a report quantity of the CSI reporting is CSI-RS indicator (CRI)-rank indicator (RI)-CQI.

16. A base station in a communication system, the base station comprising:
a transceiver; and
a controller operably coupled to the transceiver, the controller configured to:
transmit, to a terminal, configuration information on a channel state information (CSI) reporting, wherein the configuration information includes one or more sub-configurations and a sub-configuration includes a port subset indicator, and
receive, from the terminal, the CSI reporting including CSI,
wherein the port subset indicator includes a plurality of bits each of which is associated with a CSI-RS port in a plurality of CSI-RS ports for a channel measurement associated with the CSI reporting,
wherein indices of the one or more CSI-RS ports are indicated by one or more bits of a value of 1 of the port subset indicator,
wherein the CSI is based on one or more CSI-RS ports, and
wherein the indices of the one or more CSI-RS ports correspond to one or more antenna ports in an increasing order of positions of the one or more bits set to a value of 1.

17. The base station of claim 16, wherein, in case that a non precoding matrix indicator (PMI) port indication is configured for the sub-configuration, the indices of the one or more CSI-RS ports correspond to one or more antenna ports based on the non PMI port indication, and
wherein the non PMI port indication indicates at least one CSI-RS port for each rank among the one or more CSI-RS ports.

18. The base station of claim 16, wherein the CSI includes a channel quality indicator (CQI) based on the one or more CSI-RS ports.

19. The base station of claim 16, wherein the port subset indicator includes a number of bits set to a value of 1 and the number of bits set to the value of 1 is one of 1, 2, 4, or 8.

20. The base station of claim 16, wherein a report quantity of the CSI reporting is CSI-RS indicator (CRI)-rank indicator (RI)-CQI.
